(19) United States
(12) Patent Application Publication
(10) Pub. No.: US 2025/0370121 A1
(43) Pub. Date: Dec. 4, 2025

(54) RADAR APPARATUS, SYSTEM, AND METHOD

(71) Applicant: INTEL CORPORATION, Santa Clara, CA (US)

(72) Inventors: Kobi Ben Atar, Mazkeret Batya (IL); Ophir Shabtay, Tsofit (IL); Georgios C. Dogiamis, Chandler, AZ (US); Danniel Nahmanny, Givat Shapira (IL); Daniel Grodensky, Haifa (IL); Sharon Heruti, Tel-Aviv (IL); Merav Sicron, Kfar-Saba (IL)

(73) Assignee: INTEL CORPORATION, Santa Clara, CA (US)

(21) Appl. No.: 18/870,432

(22) PCT Filed: Jun. 29, 2022
(86) PCT No.: PCT/US2022/035465

§ 371 Date: Nov. 28, 2024

(51) Int. Cl. G01S 13/87; G01S 7/35; G01S 13/58; G01S 13/931

(52) U.S. Cl. CPC G01S 13/872; G01S 7/354; G01S 7/356; G01S 13/584; G01S 13/931

(57) ABSTRACT

For example, a Radio Head (RH) may include a communication interface configured to communicate with a radar processor via a communication interconnect. For example, the communication interface may be configured to receive analog synchronization information from the radar processor, and to communicate with the radar processor analog radar signals over a plurality of frequency channels. For example, the RH may include a frequency generator configured to generate a plurality of frequency signals corresponding to the plurality of frequency channels, for example based on the analog synchronization information. For example, the RH may include a plurality of radio chains to communicate radar Radio Frequency (RF) signals corresponding to the analog radar signals.

### TECHNICAL FIELD

Aspects described herein generally relate to radar apparatus, system and method.

### BACKGROUND

Various types of devices and systems, for example, autonomous and/or robotic devices, e.g., autonomous vehicles and robots, may be configured to perceive and navigate through their environment using sensor data of one or more sensor types.

Conventionally, autonomous perception relies heavily on light-based sensors, such as image sensors, e.g., cameras, and/or Light Detection and Ranging (LiDAR) sensors. Such light-based sensors may perform poorly under certain conditions, such as, conditions of poor visibility, or in certain inclement weather conditions, e.g., rain, snow, hail, or other forms of precipitation, thereby limiting their usefulness or reliability.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a radar system, in accordance with some demonstrative aspects.

FIG. 11 is a schematic illustration of a radar system, in accordance with some demonstrative aspects.

FIG. 12 is a schematic illustration of a radar system, in accordance with some demonstrative aspects.

FIG. 13 is a schematic illustration of a radar system, in accordance with some demonstrative aspects.

FIG. 14 is a schematic illustration of an interconnect scheme to support communication between a Radio Head (RH) and a radar processor via a communication interconnect, in accordance with some demonstrative aspects.

FIG. 15 is a schematic illustration of a radar system, in accordance with some demonstrative aspects.

FIG. 16 is a schematic illustration of a radar system, in accordance with some demonstrative aspects.

FIG. 17 is a schematic illustration of a radar system, in accordance with some demonstrative aspects.

FIG. 18 is a schematic illustration of a radar system, in accordance with some demonstrative aspects.

FIG. 19 is a schematic illustration of a Tx scheme to support communication between an RH and a radar processor via a communication interconnect, in accordance with some demonstrative aspects.

FIG. 20 is a schematic illustration of an Rx scheme to support communication between an RH and a radar processor via a communication interconnect, in accordance with some demonstrative aspects.

FIG. 21 is a schematic flow chart illustration of a method of radar processing, in accordance with some demonstrative aspects.

FIG. 22 is a schematic flow chart illustration of a method of radar processing, in accordance with some demonstrative aspects.

FIG. 23 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

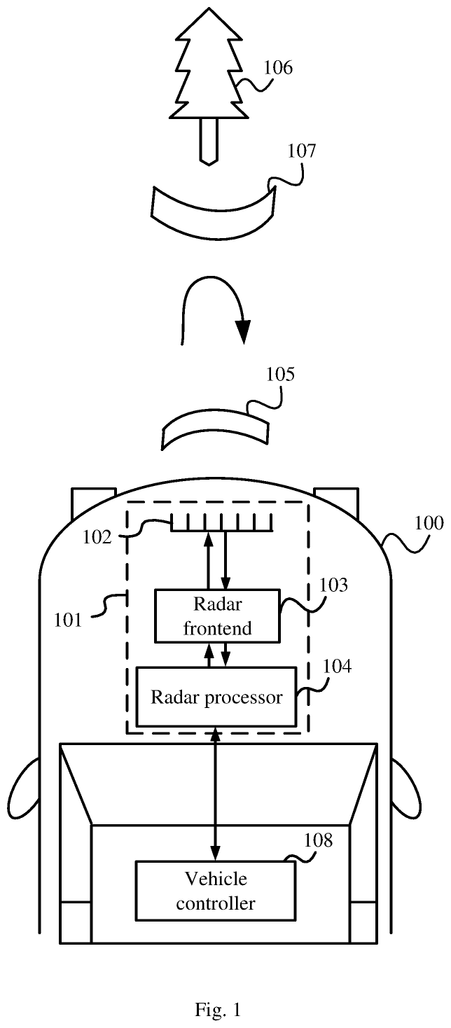

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include other vehicles; pedestrians; traffic signs; traffic lights; roads, road elements, e.g., a pavement-road meeting, an edge line; a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below. In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and a one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

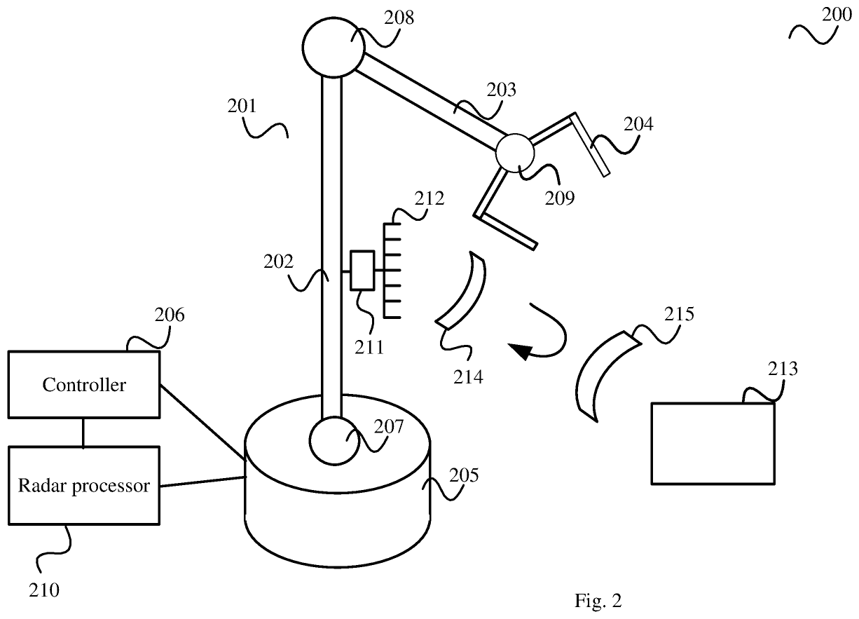

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

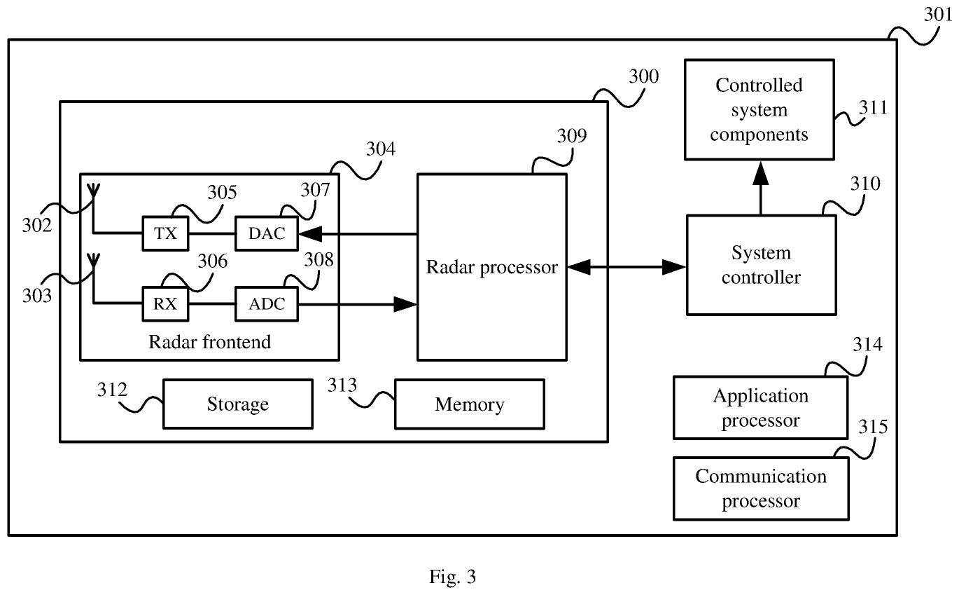

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 an/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, system controller 310 may be configured to control one or more controlled system components 311 of the system 301, e.g. a motor, a brake, steering, and the like, e.g. by one or more corresponding actuators.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated continuous wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

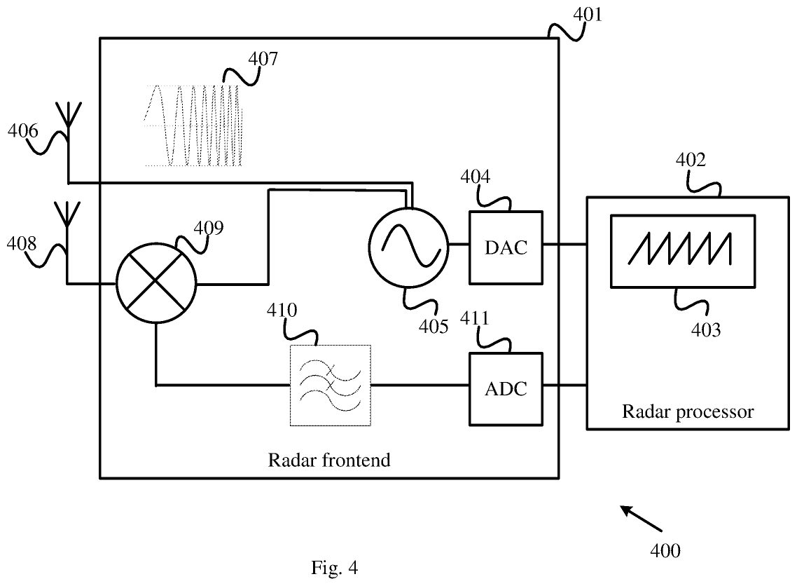

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

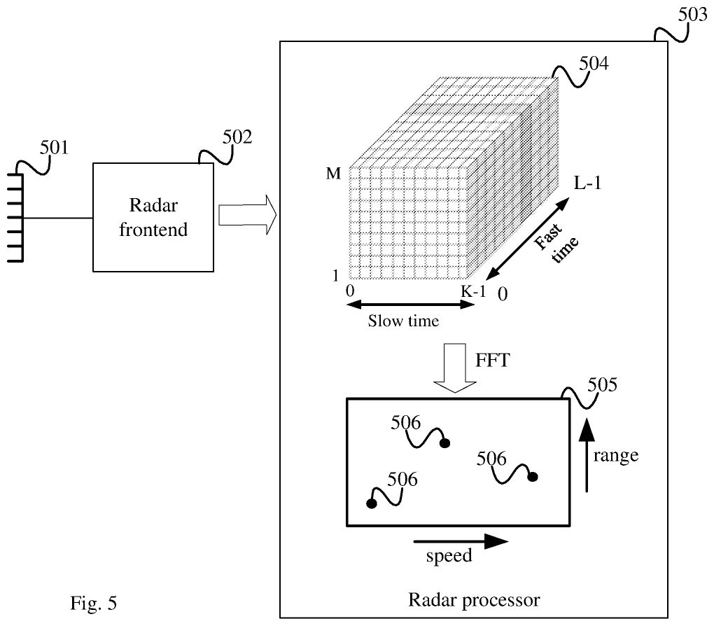

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

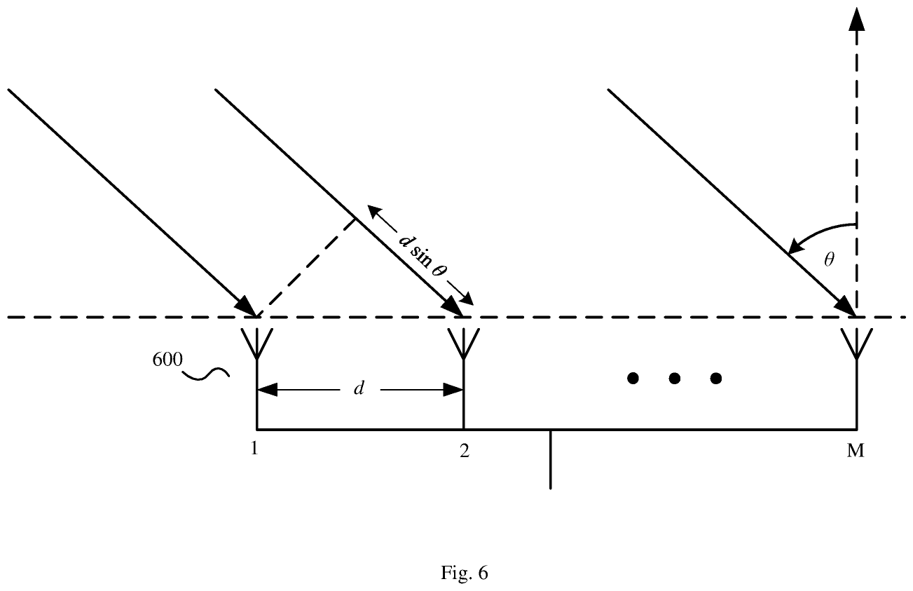

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array. In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein k denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

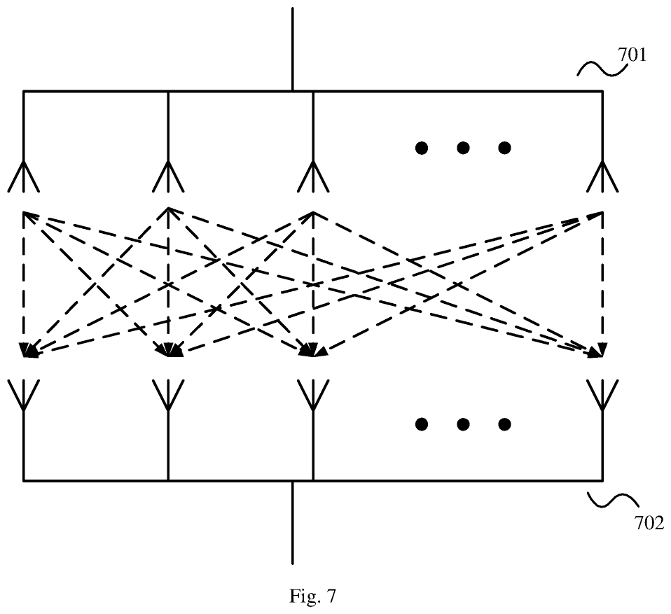

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

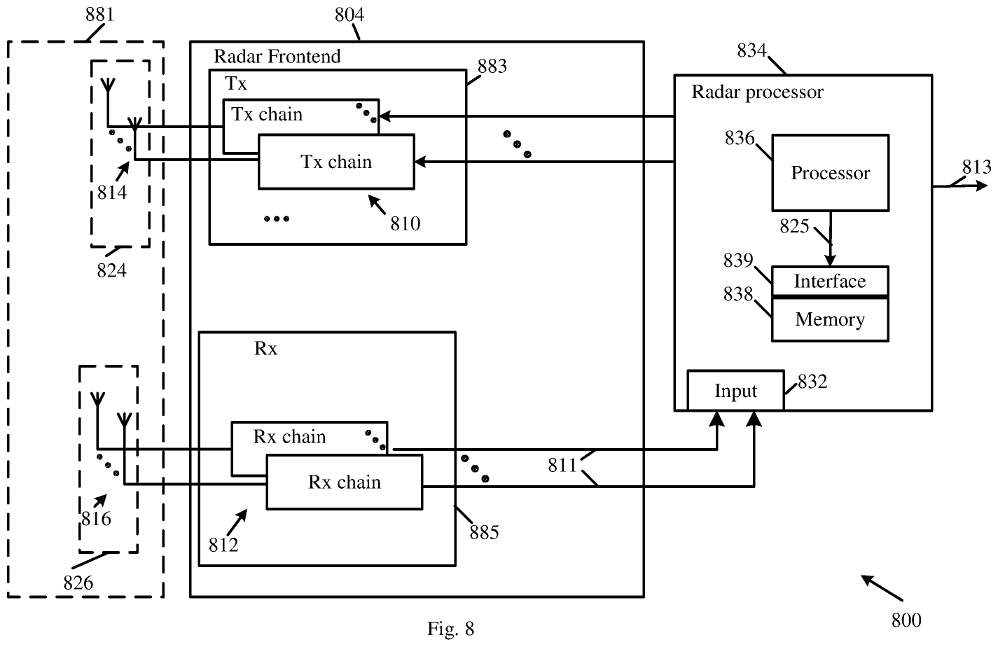

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design. In other aspects, any other form, shape and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth and/or Elevation.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

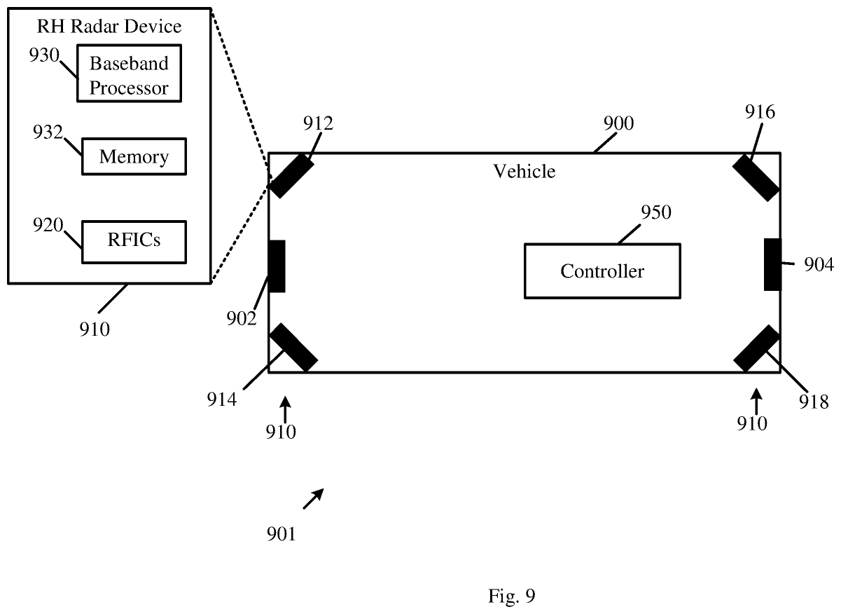

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, the plurality of RH radar devices 910 may be installed, for example, as integrated units around vehicle 900, for example, in the front, the rear, and/or corners of vehicle 900. For example, the plurality of RH radar devices 910 may be installed at a low position, e.g., at a bumper level of a bumper of vehicle 900, and/or or at a high position, e.g., on top of the vehicle 900, for example, on a roof of the vehicle.

In one example, radar devices may be positioned at dedicated high positions on vehicle 900, for example, to allow long-range detection and/or a clear Field of View (FoV).

In some demonstrative aspects, for example, in some use cases, scenarios, and/or implementations, there may be a need to address one or more technical issues of techniques implementing radar systems using radar devices, e.g., possibly of different types, each performing an entire radar functionality, e.g., from antenna processing to point cloud information or a detection list, e.g., as described below.

In one example, using different types of radar devices that perform the entire radar functionality may result in a complicated radar system.

In another example, an implementation integrating in a single radar unit all components of a radar device, e.g., RF antennas, RF and analog chains, compute algorithmic engines doing cross-correlation, Doppler processing and/or AoA processing, and/or compute engines for stateful post-processing, may result in a radar device having a relatively large size, a relatively heavy weight, and/or a relatively high power consumption.

In another example, an implementation integrating in a single radar unit all components of a radar device may suffer mechanical and/or heat-dissipation issues. For example, when all components are integrated in the same radar unit, the entire unit should be placed at a vehicle side wall, for example, due to a requirement that the antennas are to be placed at the vehicle side wall. Accordingly, this positioning of the entire radar unit at the vehicle side wall may cause mechanical and/or heat-dissipation issues.

In another example, in an implementation of a radar system including radar devices placed at separate positions, e.g., in a vehicle, it may be difficult to share data of the separate radar devices, and/or to share compute resources between the radar devices. Accordingly, such implementations may provide a non-optimized solution, as these implementations may have limited possibilities to support load-balancing and/or failover architectures.

In some demonstrative aspects, for example, in some use cases, scenarios, and/or implementations, there may be a need to address one or more technical issues of techniques implementing radar systems using joint processing of multiple radar devices, e.g., as described below.

For example, higher layer processing or joint processing of the radar devices may be performed on a single radar device or as a fusion of point cloud information or detection lists from the radar devices.

For example, joint processing may be performed based on point cloud fusion of point cloud information from multiple radar devices. The joint processing may be based on raw point cloud information from the plurality of radar devices as an input to a fusion function.

In one example, the joint processing may be limited and/or bound by a tradeoff between hard performance versus implementation efficiency, e.g., power consumption, form factors, weight, cost, or the like. For example, the larger the aperture, the better the performance. However, the better performance may be at a cost of a high complexity and/or a bulky implementation.

In some demonstrative aspects, there may be a need to address one or more technical issues of a Multi Static (MS) radar configuration, which may be implemented, for example, to enable improved radar resolution. For example, radar transmit and receive antennas of a MS radar configuration may be located at different places and/or at different RHs. For example, coherent MS radar configuration may provide improved resolution compared to a non-coherent MS radar configuration. For example, syncing different RHs to a level of picoseconds may not be a trivial task.

In some demonstrative aspects, there may be a need to provide a technical solution for joint processing of radar devices.

In some demonstrative aspects, radar system 901 may be configured to provide a technical solution to implement a radar system according to a distributed radar system architecture, which may support high performance, for example, with a light weight, low power, a compact form-factor and/or a low cost radar system, e.g., as described below.

In some demonstrative aspects, the distributed radar system architecture may be configured to provide a technical solution according, for example, to a view point of an entire vehicle, for example, to provide a sensing suit for autonomous vehicles, which may have high performance and/or a low implementation penalty. For example, the distributed radar system architecture may be configured to provide a technical solution to “break” the tradeoff between performance and implementation of an integrated radar system.

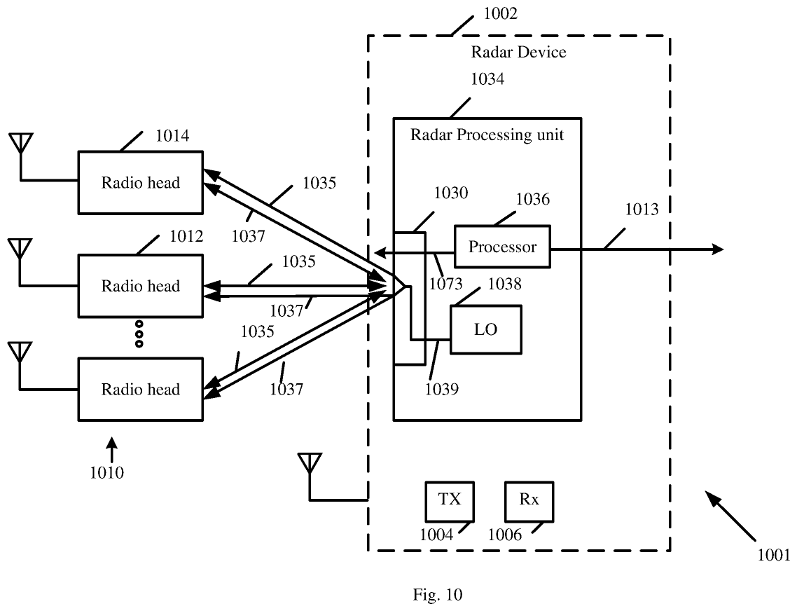

Reference is made to FIG. 10, which schematically illustrates a radar system 1001, in accordance with some demonstrative aspects. For example, radar system 901 (FIG. 9) may include one or more elements of radar system 1001, and/or may perform one or more operations and/or functionalities of radar system 1001.

In some demonstrative aspects, as shown in FIG. 10, radar system 1001 may include a plurality of RHs 1010. For example, one or more, e.g., some or all, RH radar devices of the plurality of RH radar devices 910 (FIG. 9) may include one or more elements of one or more RHs 1010, and/or may perform one or more operations and/or functionalities of one or more RHs 1010. For example, an RH radar device 910 (FIG. 9) may include one or more elements of an RH 1010, and/or may perform one or more operations and/or functionalities of an RH 1010.

In some demonstrative aspects, the plurality of RHs 1010 may include a first RH 1012, and/or a second RH 1014, e.g., as described below.

In some demonstrative aspects, as shown in FIG. 10, radar system 1001 may include a radar processing unit (also referred to as “main unit”, “main processor, “central processor”, “radar processor” or “radar controller”) 1034, which may be configured, for example, to generate radar information 1013, for example, based on radar communications by the plurality of RHs 1010, e.g., as described below.

In some demonstrative aspects, as shown in FIG. 10, radar processing unit 1034 may include a communication interface 1030 configured to communicate with the plurality of RHs 1010, e.g., as described below.

In some demonstrative aspects, the communication interface 1030 may be configured with a redundancy factor greater than 1, e.g., as described below.

In other aspects, communication interface 1030 may be configured without redundancy.

In some demonstrative aspects, radar processing unit 1034 may include a processor 1036 configured to coordinate radar communications by the plurality of RHs 1010 and to generate radar information 1013, for example, based on the radar communications by the plurality of RHs 1010, e.g., as described below.

In some demonstrative aspects, processor 1036 may include, or may be implemented, partially or entirely, by circuitry and/or logic, e.g., one or more processors including circuitry and/or logic, memory circuitry and/or logic. Additionally or alternatively, one or more functionalities of processor 1036 may be implemented by logic, which may be executed by a machine and/or one or more processors, e.g., as described below.

In some demonstrative aspects, processor 1036 may be configured to transmit synchronization information 1035 to the plurality of RHs 1010, for example, via the communication interface 1030, e.g., as described below.

In some demonstrative aspects, the synchronization information 1035 may be configured to synchronize the radar communications by the plurality of RHs 1010, e.g., as described below.

In some demonstrative aspects, processor 1036 may be configured to communicate radar information 1037 with the plurality of RHs 1010, for example, via the communication interface 1030, e.g., as described below.

In some demonstrative aspects, radar information 1037 may include, for example, radar Tx information and/or radar Rx information, which may be communicated with the plurality of RHs 1010, e.g., as described below.

In some demonstrative aspects, processor 1036 may be configured to communicate the radar Tx information and/or the radar Rx information with the plurality of RHs 1010, for example, via the communication interface 1030, e.g., as described below.

In some demonstrative aspects, the radar Tx information may be configured to configure radar Tx signals to be transmitted by one or more Tx chains of the plurality of RHs 1010, e.g., as described below.

In some demonstrative aspects, the radar Rx information may be based on radar Rx signals received by one or more Rx chains of the plurality of RHs 1010, e.g., as described below.

In some demonstrative aspects, the communication interface 1030 may include a high bandwidth (BW) cable, e.g., as described below.

In some demonstrative aspects, the communication interface 1030 may include a dielectric waveguide communication interface, for example, to communicate the synchronization information, and/or the radar information 1037, e.g., the radar Tx information and/or the radar Rx information, with the plurality of RHs 1010 via a dielectric waveguide interconnect, e.g., as described below.

In some demonstrative aspects, the communication interface 1030 may include an Active Optical Cable (AOC) communication interface, for example, to communicate the synchronization information, and/or the radar information 1037, e.g., the radar Tx information and/or the radar Rx information, with the plurality of RHs 1010 via an AOC interconnect, e.g., as described below.

In some demonstrative aspects, the communication interface 1030 may include a fiber optic communication interface, for example, to communicate the synchronization information, and/or the radar information 1037, e.g., the radar Tx information and/or the radar Rx information, with the plurality of RHs 1010 via a fiber optic interconnect, e.g., as described below.

In other aspects, the communication interface 1030 may include any other additional or alternative communication interface, for example, to communicate the synchronization information, and/or the radar information 1037, e.g., the radar Tx information and/or the radar Rx information, with the plurality of RHs 1010 via any other interconnect.

In some demonstrative aspects, the synchronization information 1035 may be configured to synchronize the radar communications by the plurality of RHs 1010, for example, in phase and/or in time, e.g., as described below.

In some demonstrative aspects, the synchronization information 1035 may include a common Local Oscillator (LO) signal 1039, for example, from an LO 1038, which may be distributed to the plurality of RHs 1010, for example, via the communication interface 1030, e.g., as described below.

In other aspects, an RH 1010, e.g., each RH 1010, may include a local LO. For example, synchronization information 1035 may include a synchronization signal for timing synchronization between local LOs of the RHs 1010, for example, to maintain coherency.

In some demonstrative aspects, the communication interface 1030 may be configured to transmit the common LO signal 1039 to the plurality of RHs 1010, for example, in the form of an analog LO signal, e.g., as described below.

In other aspects, the communication interface 1030 may be configured to transmit the common LO signal 1039 to the plurality of RHs 1010 in any other form.

In some demonstrative aspects, synchronization information 1035 may include time synchronization information to synchronize in time the radar communications by the plurality of RHs 1010.

In some demonstrative aspects, the synchronization information 1035 may include any other additional or alternative information to synchronize the radar communications by the plurality of RHs 1010, for example, in phase and/or in time.

In some demonstrative aspects, processor 1036 may be configured to transmit the radar Tx information to one or more of the RHs 1010, for example, via the communication interface 1030, e.g., as described below.

In some demonstrative aspects, processor 1036 may be configured to generate the radar Tx information, for example, to configure a MIMO radar transmission via a MIMO array formed by antennas of two or more, e.g., some or all, of the plurality of RHs 1010, e.g., as described below.

In some demonstrative aspects, processor 1036 may be configured to generate the radar Tx information to configure a simultaneous radar transmission by at least a first RH and second RH, for example, RH 1012 and/or RH 1014, e.g., as described below.

In some demonstrative aspects, the simultaneous radar transmission may include transmission of first radar Tx signals by the first RH, e.g., RH 1012, and transmission of second radar Tx signals by the second RH, e.g., RH 1014, e.g., as described below.

In some demonstrative aspects, radar system 1001 may be configured to provide a technical solution to support implementation of one or more RHs 1010, e.g., some or all RHs 1010, as analog RHs (also referred to as “thin” RHs), which may be configured to communicate analog radar information with the radar processing unit 1034, e.g., as described below.

In some demonstrative aspects, radar system 1001 may be implemented to provide a technical solution to support implementation of a “thin” RH, which may be all analog.

In some demonstrative aspects, the “thin” RH may have a small form-factor, and/or a light weight, and/or may be power-efficient.

In some demonstrative aspects, radar system 1001 may be implemented to provide a technical solution to support implementation of a radar processing unit, e.g., radar processing unit 1034 which may be configured to process analog radar signals from one or more analog RHs, e.g., RHs 1010, e.g., as described below.

In some demonstrative aspects, an RH 1010, e.g., some of the RHs 1010 or each RH 1010, may be configured as an analog RH to communicate radar information 1037 in the form of analog information, with radar processing unit 1034, and to receive from the radar processing unit 1034 the synchronization information 1039 in the form of analog information, e.g., as described below.

In some demonstrative aspects, the communication interface 1030 may be configured to transmit to an RH 1010, e.g., RH 1012 and/or RH 1014, one or more analog Tx signals for the RH, e.g., including analog Tx signals to be transmitted by one or more respective Tx chains of the RH, e.g., as described below.

In some demonstrative aspects, processor 1036 may be configured to process the radar Rx information received via the communication interface 1030, and to generate the radar information 1013, for example, based on the radar Rx information, e.g., as described below.

In some demonstrative aspects, processor 1036 may be configured to receive via communication interface 1030 one or more analog Rx signals from an RH 1010, for example, RH 1012 and/or RH 1014, e.g., as described below.

In some demonstrative aspects, the one or more analog Rx signals from the RH 1012 may be based on signals received by one or more respective Rx chains of the RH 1012; and/or the one or more analog Rx signals from the RH 1014 may be based on signals received by one or more respective Rx chains of the RH 1014, e.g., as described below.

In some demonstrative aspects, processor 1036 may be configured to receive via communication interface 1030 the radar Rx information, which may include first radar Rx information from a first RH, e.g., RH 1012, and second radar Rx information from a second RH, e.g., RH 1014, e.g., as described below.

In some demonstrative aspects, processor 1036 may be configured to generate the radar information 1013, for example, based on joint processing of the first radar Rx information from the first RH 1012 and the second radar Rx information from the second RH 1014, e.g., as described below.

In some demonstrative aspects, processor 1036 may be configured to generate the radar Tx information to configure a radar transmission from a particular RH, for example, RH 1012, e.g., as described below.

In some demonstrative aspects, processor 1036 may be configured to generate the radar information 1013, for example, by processing radar Rx information from the particular RH, e.g., from RH 1012, for example, based on the radar Tx information provided to the particular RH, e.g., as described below.

In some demonstrative aspects, processor 1036 may be configured to generate the radar Tx information to configure a radar transmission from a first RH, for example, RH 1012, e.g., as described below.

In some demonstrative aspects, processor 1036 may be configured to generate the radar information 1013 based on radar Rx information from a second RH, for example, RH 1014, e.g., as described below.

In some demonstrative aspects, the radar Rx information from the second RH 1014 may be based on the radar transmission from the first RH 1012, e.g., as described below.

In some demonstrative aspects, processor 1036 may be configured to generate the radar Tx information to configure a first radar transmission from a first RH, e.g., RH 1012, and a second radar transmission from a second RH, e.g., RH 1014.

In some demonstrative aspects, processor 1036 may be configured to generate the radar information 1013 based on radar Rx information from one or more RHs 1010, which may be configured to receive and process the first radar transmission and/or the second radar transmission.

For example, processor 1036 may be configured to generate the radar information 1013 based on radar Rx information from the first RH, from the second RH, from both the first RH and the second RH, from a third RH 1010, from the third RH and a fourth RH 1010, and/or based on any other combination of RHs 1010, which may be configured to receive and process the first radar transmission and/or the second radar transmission.

In some demonstrative aspects, processor 1036 may be configured to communicate radar control information 1073 with one or more RHs of the plurality of RHs 1010, for example, via the communication interface 1030, e.g., as described below.

In some demonstrative aspects, the radar control information 1073 for an RH 1010 may include control information to control one or more functionalities of the RH 1010, e.g., as described below.

In some demonstrative aspects, the radar control information 1073 for an RH 1010 may include Tx control information to control one or more Tx functionalities of the RH 1010.

For example, the Tx control information may include Tx parameter information to configure one or more Tx parameters to be utilized by the RH for transmission of radar Tx signals.

For example, the Tx parameter information may include waveform information to configure a Tx waveform to be utilized by the RH for transmission of radar Tx signals. For example, the Tx parameter information may include information to configure a center frequency, a bandwidth, a start time, a state machine state, and/or any other Tx parameter.

For example, the Tx control information may include Tx calibration information to configure a calibration scheme to be utilized by the RH for transmission of radar Tx signals, e.g., to account of LO delay variance, manufacturing tolerance, changes in position, and/or any other calibration purpose. For example, the Tx calibration information may include information to configure a Direct Current (DC) offset, a self-calibration, and/or any other calibration information.

In some demonstrative aspects, the radar control information 1073 for an RH 1010 may include Rx control information to control one or more Rx functionalities of the RH 1010.

For example, the Rx control information may include Rx parameter information to configure one or more Rx parameters to be utilized by the RH for processing radar Rx signals.

For example, the Rx parameter information may include waveform information to configure an Rx waveform to be received by the RH. For example, the Rx parameter information may include information to configure a center frequency, a bandwidth, a start time, a state machine state, and/or any other Rx parameter.

For example, the Rx control information may include Rx calibration information to configure a calibration scheme to be utilized by the RH for reception of radar Rx signals, e.g., to account of LO delay variance, manufacturing tolerance, changes in position, and/or any other calibration purpose. For example, the Rx calibration information may include information to configure a DC offset, a delay, a self-calibration, and/or any other calibration information.

In some demonstrative aspects, processor 1036 may be configured to communicate radar control information 1073 together with the radar information 1037, e.g., on a same channel via the communication interface 1030. For example, the processor 1036 may be configured to communicate radar control information 1073 together with the radar information 1037 over a link via communication interface 1030.

In some demonstrative aspects, processor 1036 may be configured to communicate radar control information 1073 on a control channel via the communication interface 1030, e.g., separate from a channel for the radar information 1037. In one example, the radar information 1037 may be communicated in analog form, e.g., over an analog channel; and/or the radar control information 1073 may be communicated over a digital channel, e.g., a low-rate digital channel which may be dedicated to communicate the radar control information 1073.

In some demonstrative aspects, processor 1036 may be configured to generate the radar information 1013, for example, based on installation information corresponding to an installation configuration of one or more of the plurality of RHs 1010, e.g., as described below.

In some demonstrative aspects, the installation information may include position information corresponding to positions of one or more of the plurality of RHs 1010, e.g., as described below.

For example, the position information corresponding to an RH may include location information corresponding to a location of the RH, e.g., location coordinates of the RH; orientation information corresponding to an orientation of the RH, e.g., a direction and/or angle of the RH, and/or any other type of information corresponding to a positioning, placement, directionality, and/or arrangement of the RH.

In some demonstrative aspects, the installation information may include FoV information corresponding to FoVs of one or more of the plurality of RHs 1010, e.g., as described below.

In one example, the FoV information for an RH may include FoV-blockage information to indicate a blocking of the FoV of the RH, for example, by the vehicle, e.g., as described below.

In some demonstrative aspects, the installation information may include configuration information corresponding to installed configurations of one or more of the plurality of RHs 1010.

For example, the installation information corresponding to an RH may include information of a type of the RH; information of a version of the RH, e.g., a hardware version, a software version, and/or a firmware version; and/or information of capabilities of the RH, e.g., RF capabilities, processing capabilities, hardware capabilities, and/or software capabilities.

In other aspects, the installation information may include any other additional or alternative information corresponding to an installation, position, setting, and/or configuration of one or more of the plurality of RHs 1010.

In some demonstrative aspects, the radar processing unit 1034 may be implemented, for example, as part of a radar device 1002 of radar system 1000, e.g., as described below.

In other aspects, radar processing unit 1034 may be implemented, for example, as a separate element of radar system 1000.

In other aspects, radar processing unit 1034 may be implemented, for example, as part of any other element and/or component of radar system 1000.

In some demonstrative aspects, radar device 1002 may include a transmitter 1004 and/or a receiver 1006, e.g., as described below. For example, radar device 1002 may include one or more elements of a radio device 800 (FIG. 8), and/or may perform one or more operations and/or functionalities of radio device 800 (FIG. 8).

In some demonstrative aspects, processor 1036 may be configured to control the transmitter 1004 to transmit radar Tx signals of the radar device 1002, e.g., as described below.

In some demonstrative aspects, processor 1036 may be configured to generate the radar information 1013 based on radar Rx signals received by the receiver 1006, e.g., as described below.

In some demonstrative aspects, processor 1036 may be configured to synchronize the radar communications by the plurality of RHs 1010, for example, to radar communications of the radar device 1002, e.g., as described below. For example, processor 1036 may be configured to generate the synchronization information 1035 to synchronize the radar communications by the plurality of RHs 1010, for example, to radar communications of the radar device 1002.

In some demonstrative aspects, as shown in FIG. 10, radar processing unit 1034 may be shared between a plurality of N RHs 1010.

In some demonstrative aspects, an RH 1010, e.g., each RH 1010, may be capable of up and/or down conversion of signals, e.g., BB and/or IF signals, from/to an automotive radar RF band.

In some demonstrative aspects, radar processing unit 1034 may be configured to perform signal processing of the radar communications performed by RHs 1010 and/or to control and/or synchronize the radar communications performed by RHs 1010.

In some demonstrative aspects, for example, radar processing unit 1034 may be configured to perform range processing, Doppler processing, AoA processing, Inter-frame processing, e.g., Synthetic Aperture Radar (SAR) processing, detection, reporting, interference management, and/or any other additional or alternative functionalities.

In some demonstrative aspects, radar processing unit 1034 may be configured to communicate with the plurality of RHs 1010, e.g., via interface 1030, Tx information, e.g., in the form of a signal waveform and/or any other Tx information, for an RH 1010 with Tx capabilities and/or for an RH which may have a capability to process Rx signals based on the Tx information, e.g., as described below.

In some demonstrative aspects, radar processing unit 1034 may be configured to communicate with the plurality of RHs 1010, e.g., via interface 1030, Rx information, e.g., received signals and/or any other Rx information, which may be received from an RH having Rx capabilities, e.g., as described below. For example, the Rx information from an RH may include information based on received echoes, received interference, and/or any other signals received by the RH.

In some demonstrative aspects, radar processing unit 1034 may be configured to communicate calibration information with one or more RHs of the plurality of RHs 1010, e.g., via interface 1030. In one example, the calibration information may be generated and/or communicated between radar processing unit 1034 and the RHs 1010, per RH and/or per RH RF chain.

In some demonstrative aspects, radar processing unit 1034 may be configured to transmit to the plurality of RHs 1010 the synchronization information 1035 including coherent phase and/or time synchronization (sync) signals. For example, the coherent phase and/or time synchronization (sync) signals may be provided by a centralized sync-generator module(/s), e.g., LO 1038, which may be implemented by radar processing unit 1034.

In one example, radar processing unit 1034 may be configured to transmit the synchronization information 1035 including two sync signals from two different generation modules, for example, to support different time and phase synchronization signals.

In some demonstrative aspects, the synchronization information 1035 may include a phase sync signal. For example, the phase sync signal may include an LO signal, e.g. LO signal 1039, which may be distributed from radar processing unit 1034 to the plurality of RHs 1010.

In some demonstrative aspects, radar system 1001 may be implemented to provide a technical solution to support coherent operation, e.g., phase level coherency, of the plurality of RHs 1010.

In some demonstrative aspects, radar system 1001 may be configured to implement a centralized processing by a central radar processing unit, e.g., radar processing unit 1034, which may be aware of configuration information corresponding to a configuration of the RHs 1010, for example, an array size of an array of antennas utilized by RHs 1010, a geometry of the RHs 1010, vehicle placements of the RHS 1010, an orientation of the RHs 1010, and/or any other additional or alternative information corresponding to the configuration of the RHs 1010. For example, the central radar processing unit, e.g., radar processing unit 1034, may be configured to process radar information corresponding to radar communications performed by the RHs 1010, for example, based on the configuration information corresponding to the configuration of the RHs 1010, e.g., as described below.

In some demonstrative aspects, radar system 1001 may be implemented to provide a technical solution to support central processing of radar information of the plurality of RHs 1010, for example, by radar processing unit 1034. Accordingly, radar system 1001 may be implemented to provide a technical solution to support joint processing, e.g., coherent or incoherent joint processing, and/or data based or model based joint processing, of radar information of the plurality of RHs 1010.

In some demonstrative aspects, radar system 1001 may be implemented to provide a technical solution to support a “local” coherent MS implementation, e.g., with a relatively wide effective aperture.

In some demonstrative aspects, radar system 1001 may be implemented to provide a technical solution to support a distributed MIMO array providing a very wide aperture, for example, with reduced complexity and/or reduced number of radar sensors.

In some demonstrative aspects, radar system 1001 may be implemented to provide a technical solution based on distribution of an LO signal, e.g., LO signal 1039, to the plurality of RHs 1010. Accordingly, radar system 1001 may be implemented to provide a technical solution, which does not require a dedicated LO-sync loop function, which may be costly and/or may generate estimation errors.

In some demonstrative aspects, radar system 1001 may be implemented to provide a technical solution based on distribution of an LO signal, e.g., LO signal 1039, to the plurality of RHs 1010, for example, to achieve substantially absolute synchronization, which may enable sophisticated time and/or frequency based co-existence between the plurality of RHs 1010.

In some demonstrative aspects, radar system 1001 may be implemented to provide a technical solution to support ease of installation. For example, a form factor of an RH 1010, e.g., including an antenna, may be as small as O(1 cm). Accordingly, the plurality of RHs 1010 may be installed almost anywhere in a vehicle, e.g., even at an edge of a windshield of the vehicle. For example, the plurality of RHs 1010 may be located to provide an improved FoV and/or point of view for system 1001.

In some demonstrative aspects, radar system 1001 may be implemented to provide a technical solution to support using of small, compact, low power and/or light weight RHs 1010. For example, some or all processing capabilities, which may be major heat generators and power-hungry elements of a radar system, may be implemented at a central/main processor, e.g., radar processing unit 1034. Accordingly, radar system 1001 may be implemented to provide a technical solution to support reduced power consumption and/or heat dissipation real states.

In some demonstrative aspects, radar system 1001 may be implemented to provide a technical solution using the same LO signal distributed for all RHs 1010. Accordingly, radar system 1001 may be implemented to provide a technical solution, which may not require an adaptive calibration function, for example, to sync independent LOs.

In some demonstrative aspects, radar system 1001 may be implemented to provide a technical solution to support a MS radar system configuration and/or a distributed antenna scheme, which may provide superior performance.

In some demonstrative aspects, radar system 1001 may be implemented to provide a technical solution to leverage scale to yield an economic design, e.g., as described below.

In one example, an installation position of radar processing unit 1034 may be arbitrary and, accordingly, the installation position may enable vehicle and/or equipment manufacturers, e.g., Original Equipment Manufacturers (OEMs), to optimize radar system installation, for example, for power distribution, weight balancing, heat dissipation, and/or the like.

In some demonstrative aspects, radar system 1001 may be implemented to provide a technical solution to support a single-power and/or single heat dissipation system, e.g., which may be applied only for radar processing unit 1034.

In some demonstrative aspects, radar system 1001 may be implemented to provide a technical solution to support a single data connection to a vehicle system, e.g., from radar processing unit 1034.

In some demonstrative aspects, radar system 1001 may be implemented to provide a technical solution to support a software implementation of radar processing (partial or full) in a vehicular processor and/or controller, for example, a vehicle Domain Control Unit (DCU), a Zone Control Unit (ZCU), an Electronic Control Unit (ECU), a High Power Computer (HPC) of the vehicle, and/or the like.

In some demonstrative aspects, radar system 1001 may be implemented to provide a technical solution to support a single Baseband Processing Unit (BPU), e.g., a single radar processor or radar MicroProcessor Unit (MPU). For example, processor 1036 may be configured to process signals from the plurality of RHs 1010. Accordingly, a number of different BPU chips may be reduced. Therefore, better and/or more efficient stock and/or product line management may be achieved.

In some demonstrative aspects, radar system 1001 may be implemented to provide a technical solution to support improved diversity and/or efficiency, for example, by decoupling between a radar processing unit and the RHs, for example, as long as they adhere to a same interconnect.

In one example, some vehicles, e.g., higher end vehicles, may be installed with higher end RHs, radar processing units and/or both, while other vehicles, e.g., lower end vehicles, may be installed with lower end RHs, radar processing units and/or both. For example, the higher end radar processing units may be utilized to provide additional features and/or access computation capacity.

In some demonstrative aspects, radar system 1001 may be implemented to provide a technical solution to support product de-coupling, e.g., of next generation products.

In one example, one or more of the RHs 1010 may be upgraded to a next generation, while the radar processing unit 1034 may remain at a configuration of a current generation, e.g., while having a SW update.

In another example, the radar processing unit 1034 may be upgraded, while, one or more of the RHs 1010 may remain at the same configuration.

In some demonstrative aspects, radar system 1001 may be implemented to provide a technical solution to support implementation of various types of RHs 1010, for example, RHs having large arrays versus RHs having small arrays, RHs having conformal arrays versus RHs having non-conformal arrays, and/or the like.

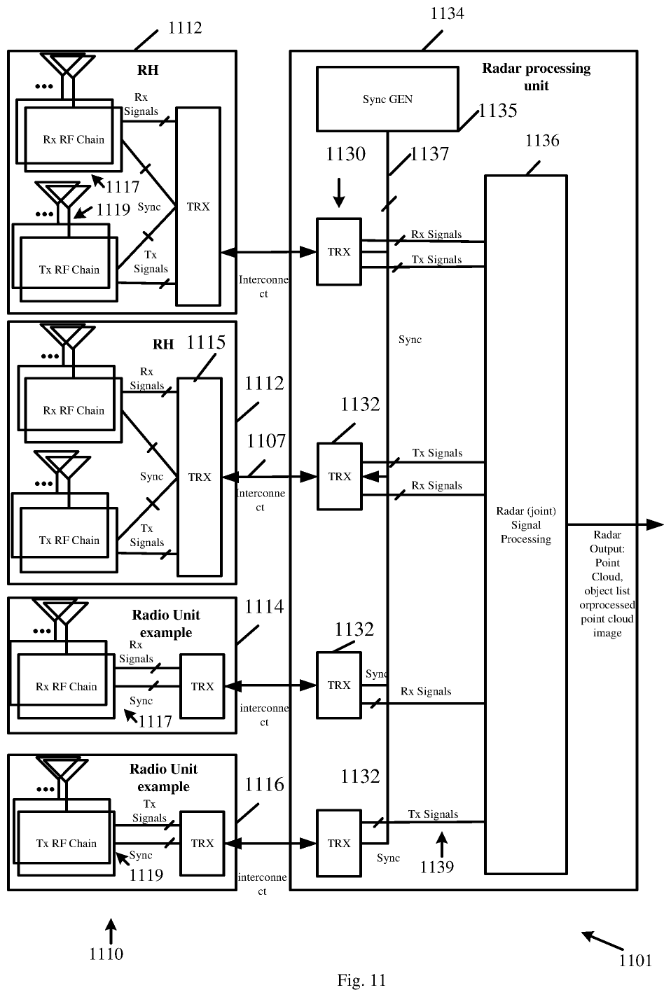

Reference is made to FIG. 11, which schematically illustrates a radar system 1101, in accordance with some demonstrative aspects. For example, radar system 1001 (FIG. 10) may include one or more elements of radar system 1101, and/or may perform one or more operations and/or functionalities of radar system 1101.

In some demonstrative aspects, as shown in FIG. 11, radar system 1101 may include a radar processing unit 1134, which may be configured to coordinate radar communications by a plurality of RHs 1110. For example, radar processing unit 1034 (FIG. 10) may include one or more elements of radar processing unit 1134, and/or may perform one or more operations and/or functionalities of radar processing unit 1134; and/or the plurality of RHs 1010 (FIG. 10) may include one or more elements of the plurality of the RHs 1110, and/or may perform one or more operations and/or functionalities of plurality of RHs 1110.

In some demonstrative aspects, as shown in FIG. 11, radarprocessing unit 1134 may include a communication interface 1130 configured to communicate with the plurality of RHs 1110. For example, communication interface 1030 (FIG. 10) may include one or more elements of communication interface 1130, and/or may perform one or more operations and/or functionalities of communication interface 1130.

In some demonstrative aspects, as shown in FIG. 11, communication interface 1130 may include a plurality of transceivers (TRX) 1132 to communicate with a respective plurality of transceivers (TRX) 1115 of the plurality of RHs 1110.

In some demonstrative aspects, as shown in FIG. 11, radar system 1101 may include a plurality of interconnects 1107, which may be configured to connect between the plurality of TRX 1132 to TRX 1115.

In some demonstrative aspects, an interconnect 1107 between TRX 1132 and TRX 1115 may include a Fiber and/or Dielectric-Waveguide interconnect.

In some demonstrative aspects, an interconnect 1107 may include a copper interconnect, e.g., including Ethernet for data and coax for sync. In one example, a copper interconnect may have some limitation, e.g., in terms of Electromagnetic interference (EMI) and/or data rates.

In some demonstrative aspects, a TRX, e.g., a TRX 1132, may be configured to aggregate a multiplicity of Rx and Tx channels, for example, to transfer signals between radar processing unit 1134 and an RH 1110.

In some demonstrative aspects, as shown in FIG. 11, the plurality of the RHs 1110 may include a plurality of different types of RHs.

In some demonstrative aspects, as shown in FIG. 11, the plurality of the RHs 1110 may include one or more RHs 1112 having both Tx capabilities and Rx capabilities. For example, the one or more RHs 1112 may include one or more Rx chains 1117, and one or more Tx chains 1119.

In one example, Rx chains 1117 may include a downconverter, an optional ADC, and/or any other Rx elements; and/or Tx chains 1119 may include an up-converter or a Tx signal generator, and/or any other Tx elements.

In some demonstrative aspects, as shown in FIG. 11, the plurality of the RHs 1110 may include one or more RHs 1114 having only Rx capabilities. For example, the one or more RHs 1114 may include one or more Rx chains 1117.

In some demonstrative aspects, as shown in FIG. 11, the plurality of the RHs 1110 may include one or more RHs 1116 having only Tx capabilities. For example, the one or more RHs 1116 may include one or more Tx chains 1119.

In some demonstrative aspects, as shown in FIG. 11, radar system 1101 may incorporate different types of RHs 1110. For example, radar system 1101 may include Tx/Rx RHs, e.g., RHs 1112, including Tx and Rx chains and antennas; a Tx-only RHs, e.g., RHs 1116, and/or Rx-only RHs, e.g., RHs 1114.

In some demonstrative aspects, an interconnect between radar processor 1134 and an RH 1110, e.g., interconnect 1107, may include an aggregation of a plurality of channels, e.g., as described below.

In some demonstrative aspects, the plurality of channels may be in the form of BB signals, analog signals, e.g., IF signals, partially processed signals, for example, Rx signals after de-chirp (fast-time), and/or any other slow time and/or fast time radar processing signals.

In some demonstrative aspects, radar system 1101 may be configured to provide a technical solution to support performing both Slow-time and Fast-time processing at a main unit, e.g., radar processing unit 1134, for example, instead of within the RHs 1110.

In some demonstrative aspects, radar system 1101 may be configured to provide a technical solution to support distribution of common sync signal/s for time and/or frequency, which may be distributed and shared, e.g., via communication interface 1130, to the RH 1110 across radar system 1101.

In some demonstrative aspects, radar processing unit 1134 may include a synchronization generator 1135, e.g., an LO, to generate an analog LO signal 1137, which may be distributed, e.g., via communication interface 1130, to the RHs 1110 across radar system 1101.

In some demonstrative aspects, the TRX 1132 may be configured to distribute sync signals from the synchronization generator 1135 to the RHS 1110, for example, with a high degree of accuracy.

In some demonstrative aspects, radar processing unit 1134 may be configured to support calibration, e.g., to account for different delay uncertainty and/or placement uncertainty of the RHs 1110.

In some demonstrative aspects, radar system 1101 may be implemented to provide a technical solution to support centralized processing, e.g., an optional joint radar processing, by a central radar processing unit, e.g., radar processing unit 1134, which may generate sync signals, timing signals, analog radar Tx signals, control signals, host reporting, and/or I/F signals, for the RHs 1110.

In some demonstrative aspects, communication interface 1130 may be configured to support a TRX module function, for example, to distribute Sync signals, e.g., sync signal 1137, and/or Tx and Rx signals between radar processing unit 1134 and the RHs 1110 of radar system 1101.

In some demonstrative aspects, radar system 1101 may be configured according a topology, for example, where some Tx channels and/or Rx channels may not be on a same board or unit. According to this topology, these Tx channels and/or Rx channels may have one or more delays, e.g., unknown temperature dependent delay-differences, which may be caused by interconnectors 1107 and/or different routing of sync signals 1137.

In some demonstrative aspects, radar processing unit 1134 may be configured to calibrate the delays, for example, by comparison to a measurement through an RH, which may include both Rx and Tx chains, e.g., RH 1112.

In some demonstrative aspects, radar processing unit 1134 may be configured to communicate analog signals via an interconnect 1107.

In some demonstrative aspects, the analog signals may include synchronization information, e.g., analog LO signal 1137.

In some demonstrative aspects, the analog signals may include signals after an analog de-chirp, e.g., a beat signal and/or a stretch signal.

In some demonstrative aspects, radar processing unit 1134 may be configured to receive Rx analog signals from an RH 1110 via an interconnect 1107, e.g., as described below.

In some demonstrative aspects, radar processing unit 1134 may be configured to transmit Tx analog signals to an RH 1110 via an interconnect 1107, e.g., as described below.

In some demonstrative aspects, radar system 1101 may be configured according to a Multi-Static (MS) radar configuration, for example, implementing a main unit, e.g., radar processing unit 1134, to receive Rx analog signals from some or all of the plurality of RHs 1110, and to jointly process them, e.g., as described below.

In some demonstrative aspects, the MS radar configuration may be partially applied, e.g., for partial functionality of radar system 1101 at a time. For example, radar processing unit 1134 may be configured to control RHs 1110 such that one or more RHs 1110, e.g., some or all RHs 1110, transmit radar signals, while one or more RHs 1110, e.g., some or all RHs 1110, receive the radar signals. In one example, radar processing unit 1134 may be configured to control RHs 1110 such that one RH 1110 transmits radar signals, while all RHs 1110 receive the radar signals. In another example, radar processing unit 1134 may be configured to control RHs 1110 such that all RHs 1110 transmit radar signals, while one RH 1110 receives the radar signals. In other aspects, radar processing unit 1134 may be configured to control RHs 1110 according to any other temporal any other combination of Tx and Rx elements, e.g., from a super set of the entire antenna elements available from the plurality of RHs 1110.

In some demonstrative aspects, radar system 1101 may be configured according to an architecture (satellite architecture), in which a main processing unit, e.g., radar processing unit 1134, and a radio unit, e.g., an RH 1110, are integrated. For example, radar processing unit 1134 may be implemented together with an RH 1112. For example, the radar system 1101 may include a main unit, e.g., including an RH and a radar processor, and a plurality of RH satellites, e.g., having only an RH functionality.

In some demonstrative aspects, the main unit may be augmented with the satellite units, for example, to enhance performance for joint processing over a larger aperture size. For example, radar system 1101 may be configured to utilize a virtual radar array formed by antenna arrays of the main unit and antenna arrays of the satellites.

In some demonstrative aspects, the RHs 1110 may be implemented to provide a distributed antenna including antenna elements, e.g., which do not reside in a same module.

In some demonstrative aspects, the distributed antenna may be implemented as a uniform antenna array, e.g., a Uniform Linear Array (ULA), or as a non-uniform antenna array, e.g., a non-ULA; as a 2D or 3D antenna, e.g., when elements are not on a same 2D plane; and/or as a conformal or non-conformal array.

In some demonstrative aspects, Tx and Rx arrays of the distributed antenna may be interchangeable.

In some demonstrative aspects, radar processing unit 1134 may include a processor 1136 configured to coordinate radar communications by the plurality of RHs 1111, and to generate radar information 1113, for example, based on the radar communications by the plurality of RHs 1110. For example, processor 1036 (FIG. 10) may include one or more elements of processor 1136, and/or may perform one or more operations and/or functionalities of processor 1136.

In some demonstrative aspects, processor 1136 may include, or may be implemented, partially or entirely, by circuitry and/or logic, e.g., one or more processors including circuitry and/or logic, memory circuitry and/or logic. Additionally or alternatively, one or more functionalities of processor 1136 may be implemented by logic, which may be executed by a machine and/or one or more processors.

In some demonstrative aspects, processor 1136 may be configured to communicate analog radar signals 1139 with the plurality of RHs 1110, for example, via the communication interface 1130.

In some demonstrative aspects, analog radar signals 1139 may include, for example, analog radar Tx signals and/or analog radar Rx signals, which may be communicated with the plurality of RHs 1110.

In some demonstrative aspects, the analog radar Tx signals may be configured to configure radar Tx RF signals to be transmitted by one or more Tx chains of the plurality of RHs 1110.

In some demonstrative aspects, the analog radar Rx signals may be based on radar Rx RF signals received by one or more Rx chains of the plurality of RHs 1110.

In some demonstrative aspects, as shown in FIG. 11, radar system 1101 may be implemented according to a system architecture utilizing two types of units, e.g., the plurality of RHs 1110 and the radar processor 1136.

In some demonstrative aspects, an RH 1110, e.g., each RH 1110, may reside at vehicle side walls of a vehicle.

In some demonstrative aspects, radar processor 1136 may include radar components configured to perform digital signal processing of radar signals, control, and/or SW tasks.

In some demonstrative aspects, radar processor 1136 may reside at any suitable position of the vehicle.

In some demonstrative aspects, as shown in FIG. 11, radar processing unit 1134 and the plurality of RHs 1110 may be connected via the plurality of interconnects 1107, e.g., using a plurality of high-BW cables.

In some demonstrative aspects, radar processing unit 1134 may process the radar Rx information from the plurality of RHs 1110, for example, in a centralized manner.

In some demonstrative aspects, radar processor 1136 may be configured to provide a technical solution to improve system performance of radar system 1101, and/or to reduce system power consumption, system area, and/or system cost of radar system 1101, e.g., as described below.

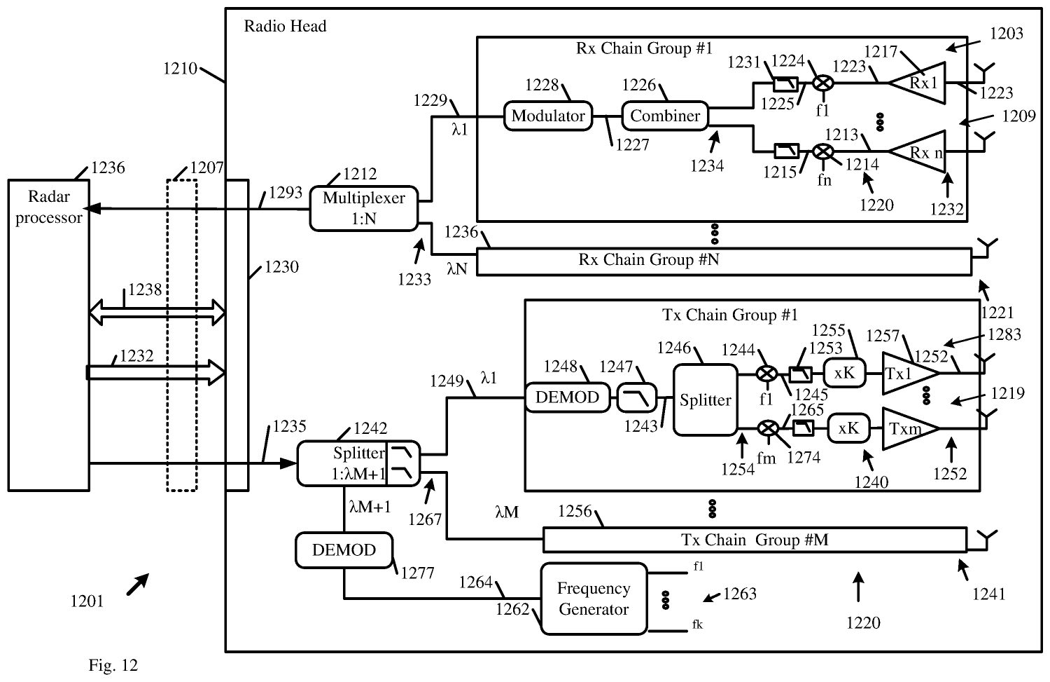

Reference is made to FIG. 12, which schematically illustrates a radar system 1201, in accordance with some demonstrative aspects. For example, radar system 1101 (FIG. 11) may include one or more elements of radar system 1201, and/or may perform one or more operations and/or functionalities of radar system 1201.

In some demonstrative aspects, as shown in FIG. 12, radar system 1201 may include a radar processor 1236. For example, radar processor 1236 may include one or more elements of radar processing unit 1034 (FIG. 10), radar processor 1036 (FIG. 10), radar processing unit 1134 (FIG. 11) and/or radar processor 1136 (FIG. 11), and/or may perform one or more operations and/or functionalities of radar processing unit 1034 (FIG. 10), radar processor 1036 (FIG. 10), radar processing unit 1134 (FIG. 11) and/or radar processor 1136 (FIG. 11).

In some demonstrative aspects, as shown in FIG. 12, radar system 1201 may include one or more RHs, e.g., including an RH 1210. For example, RH 1010 (FIG. 10), and/or RH 1110 (FIG. 11), may include one or more elements of RH 1210, and/or may perform one or more operations and/or functionalities of RH 1210.

In some demonstrative aspects, as shown in FIG. 12, RH 1210 may include a communication interface 1230 configured to communicate with radar processor 1236 via a communication interconnect 1207, e.g., as described below. For example, TRX 1115 (FIG. 11) may include one or more elements of communication interface 1230, and/or may perform one or more operations and/or functionalities of communication interface 1230; and/or communication interconnect 1107 (FIG. 11) may include one or more elements of communication interconnect 1207, and/or may perform one or more operations and/or functionalities of communication interconnect 1207.

In some demonstrative aspects, communication interface 1230 may be configured to receive analog synchronization information 1232 from the radar processor 1236, and to communicate with the radar processor 1236 analog radar signals 1238 over a plurality of frequency channels, e.g., as described below.

In some demonstrative aspects, the analog radar signals 1238 may include analog radar Rx signals 1234, e.g., as described below.

In some demonstrative aspects, the analog radar signals 1238 may include analog radar Tx signals 1254, e.g., as described below.

In some demonstrative aspects, communication interface 1230 may be configured to communicate the analog radar signals 1238 modulated over one or more first electromagnetic waveforms via a waveguide interconnect, and/or to communicate the analog synchronization information 1232 over a second electromagnetic waveform via the waveguide interconnect, e.g., as described below.

In other aspects, communication interface 1230 may be configured to communicate the analog radar signals 1238 and the analog synchronization information 1232 modulated over a common electromagnetic waveform.

In some demonstrative aspects, communication interface 1230 may include a fiber optic communication interface configured to communicate the analog synchronization information 1232, and/or the analog radar signals 1238 via a fiber optic interconnect, e.g., as described below.

In some demonstrative aspects, communication interface 1230 may include an AOC communication interface configured to communicate the analog synchronization information 1232, and/or the analog radar signals 1238 via an AOC interconnect, e.g., as described below.

In some demonstrative aspects, communication interface 1230 may include a dielectric waveguide communication interface configured to communicate the analog synchronization information 1232, and the analog radar signals 1238 via a dielectric waveguide interconnect, e.g., as described below.

In other aspects, communication interface 1230 may include any other additional or alternative type of communication interface to communicate the analog synchronization information 1232 and/or the analog radar signals 1238.

In some demonstrative aspects, as shown in FIG. 12, RH 1210 may include a frequency generator 1262 configured to generate a plurality of frequency signals 1263, e.g., including k frequency signals denoted f1 . . . fk, for example, based on the analog synchronization information 1238, e.g., as described below.

In some demonstrative aspects, frequency generator 1262 may be configured to generate the plurality of frequency signals 1263 corresponding, for example, to the plurality of frequency channels utilized to communicate the analog radar signals 1238, e.g., as described below.

In some demonstrative aspects, RH 1210 may include a plurality of radio chains to communicate radar RF signals corresponding to the analog radar signals 1238, e.g., as described below.

In some demonstrative aspects, the plurality of radio chains may include a plurality of Rx chains 1220, and/or a plurality of Tx chains 1240, e.g., as described below.

In some demonstrative aspects, a radio chain of the plurality of radio chains may be configurable by a frequency signal 1263 of the plurality of frequency signals 1263, for example, to process an analog radar signal in a frequency channel corresponding to the frequency signal 1263, e.g., as described below.

For example, an analog radar signal 1238 may include an analog radar Rx signal 1234, which may be based on a radar Rx RF signal received by an Rx chain 1220, e.g., as described below.

For example, an analog radar signal 1238 may include an analog radar Tx signal 1254 to configure a radar Tx RF signal to be transmitted by a Tx chain 1240, e.g., as described below.

In some demonstrative aspects, as shown in FIG. 12, the RH 1210 may include a plurality of groups of radio chains, which may be implemented, for example, by a plurality of chips (also referred to as “System-In-Package (SIP) chips”), e.g., as described below.

In some demonstrative aspects, the plurality of groups of radio chains may include a plurality of Rx chain groups 1221, which may be implemented, for example, by a plurality of chips (also referred to as a “Rx SIP (RxSip)”), denoted Rx #1-Rx #N.

In some demonstrative aspects, the plurality of groups of radio chains may include a plurality of Tx chain groups 1241, which may be implemented, for example, by a plurality of chips (also referred to as a “Tx SIP (TxSip)”), denoted Tx #1-Tx #M.

In some demonstrative aspects, as shown in FIG. 12, the frequency generator 1262 may be configured to provide the plurality of frequency signals 1263 to the plurality of groups of radio chains 1221 and/or 1241, e.g., as described below.

In some demonstrative aspects, communication interface 1230 may be configured to communicate with the radar processor 1236 a multiplexed analog radar signal over an interconnect frequency bandwidth including a plurality of interconnect frequency channels, e.g., as described below.

In some demonstrative aspects, the multiplexed analog radar signal may include a plurality of modulated analog radar signals over the plurality of interconnect frequency channels, respectively, e.g., as described below.

In some demonstrative aspects, a modulated analog radar signal may be based on a combined analog radar signal including a plurality of analog radar signals over the plurality of frequency channels utilized to communicate the analog radar signals 1238, e.g., as described below.

In some demonstrative aspects, a group of radio chains, e.g., a group of Rx chains 1221 and/or a group of Tx chains 1241, may be configured to process the plurality of analog radar signals of the combined analog radar signal, e.g., as described below.

In some demonstrative aspects, the analog synchronization information 1232 may include an analog LO signal 1264, e.g., as described below.

In some demonstrative aspects, the analog synchronization information 1232 may include time synchronization information to synchronize in time the radar RF signals communicated by the RH 1210, e.g., as described below.

In other aspects, the analog synchronization 1232 may include any other additional and/or alternative information.

In some demonstrative aspects, as shown in FIG. 12, the plurality of Rx chains 1220 may be configured to generate the plurality of analog radar Rx signals 1234, for example, based on a plurality of radar Rx RF signals 1232, e.g., as described below.

In some demonstrative aspects, communication interface 1230 may be configured to send the plurality of analog radar Rx signals 1234 to the radar processor 1236, for example, over a plurality of Rx frequency channels, for example, including n Rx frequency channels, denotedfl-fn, e.g., as described below.

In some demonstrative aspects, as shown in FIG. 12, the plurality of Rx chains 1220 may include a first Rx chain, e.g., RX chain 1203, and a second Rx chain, e.g., an Rx chain 1209, e.g., as described below.

In some demonstrative aspects, as shown in FIG. 12, Rx chain 1203 may include an Rx mixer 1224 configured to provide an analog radar Rx signal 1225 over an Rx frequency channel, for example, by mixing a radar Rx RF signal 1223 with a frequency signal 1263 corresponding to the Rx frequency channel, e.g., as described below.

In one example, Rx mixer 1224 may be configured to down-convert the radar Rx RF signal 1223 into a low-intermediate frequency.

In some demonstrative aspects, as shown in FIG. 12, the Rx chain 1203 may include a filter 1231 configured to filter the analog radar Rx signal 1225.

In some demonstrative aspects, as shown in FIG. 12, the second Rx chain 1209 may include a second Rx mixer 1214 to provide a second analog radar Rx signal 1215 over a second Rx frequency channel, for example, by mixing a second radar Rx RF signal 1213 with a second frequency signal corresponding to the second Rx frequency channel, e.g., as described below.

In some demonstrative aspects, as shown in FIG. 12, the Rx chain 1209 may include a filter configured to filter the analog radar Rx signal 1215.

In some demonstrative aspects, as shown in FIG. 12, the RH 1210 may include a combiner 1226 configured to combine the plurality of analog radar Rx signals 1234 into a combined Rx signal 1227 over a frequency bandwidth including the plurality of Rx frequency channels, e.g., as described below.

In some demonstrative aspects, as shown in FIG. 12, the RH 1210 may include a modulator 1228 configured to modulate the combined Rx signal 1227 into a modulated Rx signal 1229 over an interconnect frequency channel, e.g., as described below.

In some demonstrative aspects, as shown in FIG. 12, communication interface 1230 may be configured to transmit the modulated Rx signal 1229 to the radar processor 1236, e.g., as described below.

In some demonstrative aspects, as shown in FIG. 12, the plurality of groups 1221 of Rx chains may be configured to generate a plurality of modulated Rx signals 1233, e.g., including N modulated Rx signals 1233, denoted #λ1-#λN, over a respective plurality of interconnect frequency channels, e.g., as described below.

In some demonstrative aspects, as shown in FIG. 12, the RH 1210 may include a multiplexer 1212 to generate a multiplexed Rx signal 1293, for example, by multiplexing the plurality of modulated Rx signals 1233, e.g., as described below.

In some demonstrative aspects, as shown in FIG. 12, the communication interface 1230 may be configured to transmit the multiplexed Rx signal 1293 to the radar processor 1236, e.g., as described below.

In some demonstrative aspects, as shown in FIG. 12, the communication interface 1230 may be configured to receive the plurality of analog radar Tx signals 1254 from the radar processor 1236 over a plurality of Tx frequency channels, for example, including m frequency channels, denoted f1-fm, e.g., as described below.

In some demonstrative aspects, as shown in FIG. 12, the plurality of Tx chains 1240 may be configured to transmit a plurality of radar Tx RF signals 1252, for example, based on the plurality of analog radar Tx signals 1254, e.g., as described below.

In some demonstrative aspects, the plurality of Tx chains 1240 may include a first Tx chain 1283 and/or a second Tx chain 1219.

In some demonstrative aspects, as shown in FIG. 12, Tx chain 1283 may be configured to transmit a radar Tx RF signal 1252 based on an analog radar Tx signal 1254 over a Tx frequency channel, e.g., as described below.

In some demonstrative aspects, as shown in FIG. 12, the first Tx chain 1283 may include a first Tx mixer 1244 to provide an IF signal 1245, for example, by mixing a combined Tx signal 1243 with a frequency signal 1263 corresponding to the Tx frequency channel for the Tx chain 1283, e.g., as described below.

In some demonstrative aspects, the second Tx chain 1219 may include a second Tx mixer 1274 to provide a second IF signal 1265, for example, by mixing the combined Tx signal 1243 with a second frequency signal 1263 corresponding to a second Tx frequency channel for the Tx chain 1219, e.g., as described below.

In some demonstrative aspects, as shown in FIG. 12, the combined Tx signal 1243 may include the plurality of analog radar Tx signals 1254 over a frequency bandwidth including the plurality of Tx frequency channels, e.g., as described below.

In some demonstrative aspects, as shown in FIG. 12, the radar Tx RF signal 1252 transmitted by Tx chain 1283 may be based on the IF signal 1245, e.g., as described below.

In some demonstrative aspects, as shown in FIG. 12, the radar Tx RF signal 1252 transmitted by Tx chain 1219 may be based on the IF signal 1265, e.g., as described below.

In some demonstrative aspects, as shown in FIG. 12, the RH 1210 may include a demodulator 1248 to provide the combined Tx signal 1243, for example, by demodulating a modulated Tx signal 1249 over an interconnect frequency channel, e.g., as described below.

In some demonstrative aspects, as shown in FIG. 12, the RH 1210 may include a splitter 1246 to provide the combined Tx signal 1243 to the plurality of Tx chains 1240, e.g., as described below.

In some demonstrative aspects, as shown in FIG. 12, communication interface 1230 may be configured to receive from the radar processor 1236 a multiplexed Tx signal 1235 over an interconnect frequency bandwidth including a plurality of interconnect frequency channels, e.g., as described below.

In some demonstrative aspects, as shown in FIG. 12, the RH 1210 may include a splitter 1242 to split the multiplexed Tx signal 1235 into a plurality of modulated Tx signals 1267, e.g., including M modulated Tx signals modulated over M waveforms, denoted #λ1-#λM, over the plurality of interconnect frequency channels, respectively.

In some demonstrative aspects, the analog LO signal 1264 may be multiplexed together with the multiplexed Tx signal 1235. For example, the analog LO signal 1264 may be modulated over an M+1 interconnect frequency channel.

In some demonstrative aspects, as shown in FIG. 12, RH 1210 may include a demodulator 1277, which may be configured to demodulate the analog LO signal 1264 from the interconnect frequency channel M+1.

In some demonstrative aspects, as shown in FIG. 12, the plurality of groups 1241 of Tx chains may be configured to process the plurality of modulated Tx signals 1267, respectively, e.g., as described below.

In some demonstrative aspects, as shown in FIG. 12, a group of Tx chains 1241, e.g., each group 1241 of Tx chains, may be configured to process m channels, which may support m Tx antennas or more.

In some demonstrative aspects, as shown in FIG. 12, an input to the group of Tx chains 1241 may include aggregated waveforms, e.g., combined Tx signal 1243, which may be received from communication interface 1230, via interconnect 1207, e.g., via a fiber/waveguide link, demodulated to low-intermediate frequency, e.g., by demodulator 1248, filtered, e.g., by a filter 1247, and split, e.g., by splitter 1246 to the m Tx chains 1240.

In some demonstrative aspects, as shown in FIG. 12, a Tx chain 1240, e.g., each Tx chain 1240, may be configured to extract a specific waveform, for example, by down-converting the specific channel to baseband, e.g., by mixer 1244, followed by filtering, e.g., by a filter 1253.

In some demonstrative aspects, as shown in FIG. 12, a Tx chain 1240, e.g., each Tx chain 1240, may include a multiplier 1255 configured to multiply the IF signal 1245 to a radar frequency range, e.g., a mmWave range, and an amplifier 1257 to amplify the IF signal 1245.

In some demonstrative aspects, a group of the plurality of groups of Rx chains 1221, e.g., each group 1221 of Rx chains, may be configured to aggregate a waveform, for example, utilizing subdivisions of a total bandwidth, e.g., as described below.

In some demonstrative aspects, as shown in FIG. 12, an Rx chain 1220, e.g., each Rx chain 1220, may include a Low Noise Amplifier (LNA) 1217 configured to amplify the RF Rx radar signal 1223.

In some demonstrative aspects, as shown in FIG. 12, RH 1210 may include N RxSIPs 1221 and M TxSIPs 1241.

In some demonstrative aspects, signals of a SIP, e.g., each SIP of the N RxSIPs and M TxSIPs, may be modulated to a different optical wavelength and then multiplexed, for example, to complete an aggregation of a full bandwidth, e.g., including N+M waveforms.

In some demonstrative aspects, the frequency generator 1262 may be configured to generate an analog LO signal, which may be provided to up and down converters of the Rx chains 1220 and/or the Tx chains 1240 of RH 1210, e.g., mixer 1224, mixer 1214, mixer 1244, mixer 1274, and/or any other mixers of RH 1210.

In some demonstrative aspects, frequency generator 1262 may generate the analog LO signal, for example, based on a synchronized LO-signal from processor 1236, e.g., as may be received in synchronization information 1232.

In some demonstrative aspects, the analog synchronization information 1232 from radar processor 1236 may be modulated on a dedicated optical wavelength.

In some demonstrative aspects, a number of frequency tones, denoted k, generated by frequency generator 1262 may be equal than or greater than a maximal number of receive or transmit chains in an SIP, for example, in each SIP, e.g., k>=max(m,n).

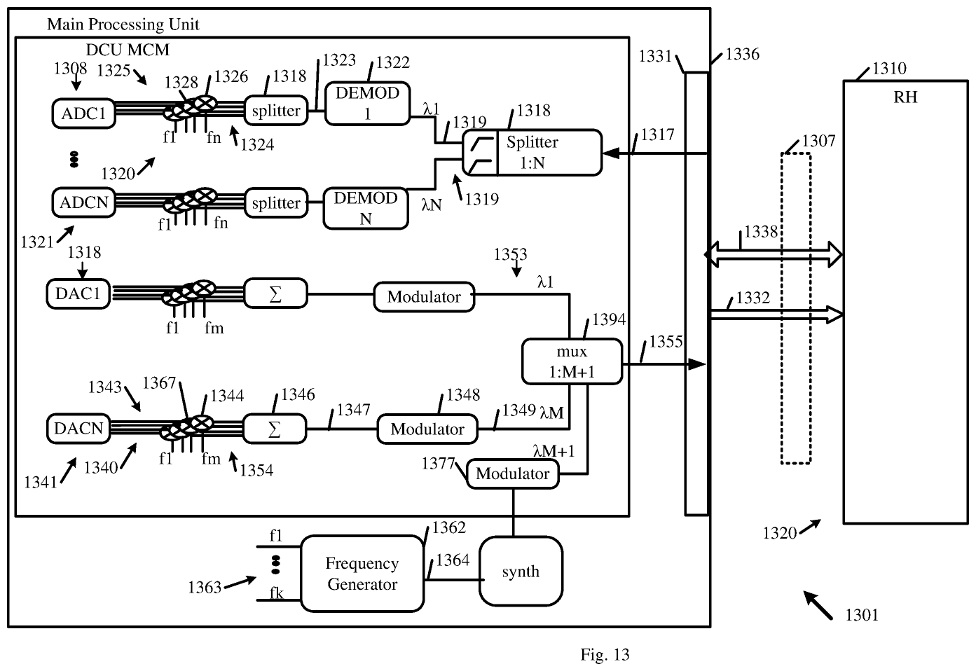

Reference is made to FIG. 13, which schematically illustrates a radar system 1301, in accordance with some demonstrative aspects. For example, radar system 1101 (FIG. 11) may include one or more elements of radar system 1301, and/or may perform one or more operations and/or functionalities of radar system 1301.

In some demonstrative aspects, as shown in FIG. 13, radar system 1301 may include one or more RHs 1310. For example, an RH 1310 may include one or more elements of RH 1210 (FIG. 12), and/or may perform one or more operations and/or functionalities of RH 1210 (FIG. 12).

In some demonstrative aspects, as shown in FIG. 13, radar system 1301 may include a radar processor 1336. For example, radar processor 1336 may include one or more elements of radar processing unit 1134 (FIG. 11) and/or radar processor 1136 (FIG. 11), and/or may perform one or more operations and/or functionalities of radar processing unit 1134 (FIG. 11) and/or radar processor 1136 (FIG. 11).

In some demonstrative aspects, as shown in FIG. 13, radar processor 1336 may include a communication interface 1331 configured to communicate with an RH 1310 via a communication interconnect 1307, e.g., as described below. For example, communication interface 1130 (FIG. 11) may include one or more elements of communication interface 1330, and/or may perform one or more operations and/or functionalities of communication interface 1330; and/or communication interconnect 1107 (FIG. 11) may include one or more elements of communication interconnect 1307, and/or may perform one or more operations and/or functionalities of communication interconnect 1307.

In some demonstrative aspects, as shown in FIG. 13, the radar processor 1336 may be configured to demodulate and split analog Rx waveforms from the RHs 1310, e.g., from the plurality of groups 1221 (FIG. 12) of Rx chains, e.g., as described below.

For example, the analog Rx waveforms may be received via the communication interconnect 1307, e.g., via an optical fiber or a waveguide interconnect. For example, the radar processor 1336 may be configured to provide data of the analog Rx waveforms to a plurality of ADCs 1308, e.g., as described below. For example, the ADCs 1308 may be configured to convert h analog Rx waveforms into digital Rx information.

In some demonstrative aspects, as shown in FIG. 13, the radar processor 1336 may be configured to convert, aggregate and upconvert Tx waveforms, which may be generated by a plurality of DACs 1318, into an optical wavelength to be sent to the RH 1310 via the communication interconnect 1307, e.g., as described below.

In some demonstrative aspects, communication interface 1330 may be configured to transmit to the RH 1310 analog synchronization information 1332, e.g., as described below.

In some demonstrative aspects, communication interface 1330 may be configured to communicate with the RH 1310 analog radar signals 1338 over a plurality of frequency channels, e.g., as described below.

In some demonstrative aspects, the analog radar signals 1338 may include analog radar Rx signals 1324, e.g., as described below.

In some demonstrative aspects, the analog radar signals 1338 may include analog radar Tx signals 1354, e.g., as described below.

In some demonstrative aspects, communication interface 1331 may be configured to communicate the analog radar signals 1338 modulated over one or more first electromagnetic waveforms via a waveguide interconnect, and/or to communicate the analog synchronization information 1332 over a second electromagnetic waveform via the waveguide interconnect, e.g., as described below.

In other aspects, communication interface 1330 may be configured to communicate the analog radar signals 1338 and the analog synchronization information 1332 modulated over a common electromagnetic waveform.

In some demonstrative aspects, communication interface 1331 may include a fiber optic communication interface configured to communicate the analog synchronization information 1332, and/or the analog radar signals 1338 via a fiber optic interconnect, e.g., as described below.

In some demonstrative aspects, communication interface 1331 may include an AOC communication interface configured to communicate the analog synchronization information 1332, and/or the analog radar signals 1338 via an AOC interconnect, e.g., as described below.

In some demonstrative aspects, communication interface 1331 may include a dielectric waveguide communication interface configured to communicate the analog synchronization information 1332, and the analog radar signals 1338 via a dielectric waveguide interconnect, e.g., as described below.

In other aspects, communication interface 1330 may include any other additional or alternative type of communication interface to communicate the analog synchronization information 1332, and the analog radar signals 1338 via any other interconnect.

In some demonstrative aspects, the analog synchronization information 1332 may include an analog LO signal 1364, e.g., as described below.

In some demonstrative aspects, the analog LO signal 1364 may be multiplexed together over an M+1 interconnect frequency channel.

In some demonstrative aspects, as shown in FIG. 13, radar processor 1336 may include a modulator 1377, which may be configured to modulate the analog LO signal 1364 over the M+1 interconnect frequency channel.

In some demonstrative aspects, the analog synchronization information 1332 may include time synchronization information to synchronize in time the communications of the one or more RHs 1310, e.g., as described below.

In some demonstrative aspects, as shown in FIG. 13, radar processor 1336 may include a frequency generator 1362 configured to generate a plurality of frequency signals 1363 corresponding to the plurality of frequency channels 1363, for example, based on the LO signal 1364 included in analog synchronization information 1338, e.g., as described below.

In some demonstrative aspects, as shown in FIG. 13, radar processor 1336 may include a plurality of analog chains to process the analog radar signals 1338, e.g., as described below.

In some demonstrative aspects, the plurality of analog chains may include a plurality of Tx analog chains 1340, and/or a plurality of Rx analog chains 1320, e.g., as described below.

In some demonstrative aspects, as shown in FIG. 13, an analog chain of the plurality of analog chains may be configurable by a frequency signal 1363 of the plurality of frequency signals 1363, for example, to process an analog radar signal in a frequency channel corresponding to the frequency signal 1363, e.g., as described below.

In some demonstrative aspects, as shown in FIG. 13, the plurality of Tx analog chains 1340 may be configured to generate a plurality of analog radar Tx signals 1354 over a plurality of Tx frequency channels, e.g., including the m Tx frequency channels f1-fm, e.g., as described below.

In some demonstrative aspects, as shown in FIG. 13, the communication interface 1331 may be configured to send the plurality of analog radar Tx signals 1354 to the RH 1310, e.g., as described below.

In some demonstrative aspects, as shown in FIG. 13, the plurality of Tx analog chains 1340 may include a first Tx analog chain and a second Tx analog chain, e.g., as described below.

In some demonstrative aspects, as shown in FIG. 13, the first Tx chain of the plurality of Tx chains 1340 may include a Tx mixer 1344 to provide a first analog radar Tx signal 1354 over a first Tx frequency channel, for example, by mixing a first analog baseband Tx signal 1343 with a first frequency signal 1363 corresponding to the first Tx frequency channel, e.g., as described below.

In some demonstrative aspects, as shown in FIG. 13, the second Tx analog chain may include a second Tx mixer 1367 to provide a second analog radar Tx signal 1354 over a second Tx frequency channel, for example, by mixing a second analog baseband Tx signal 1343 with a second frequency signal 1363 corresponding to the second Tx frequency channel.

In some demonstrative aspects, as shown in FIG. 13, radar processor 1336 may include a combiner 1346 to combine the plurality of analog radar Tx signals 1354 into a combined Tx signal 1347 over a frequency bandwidth including the plurality of Tx frequency channels, e.g., as described below.

In some demonstrative aspects, as shown in FIG. 13, radar processor 1336 may include a modulator 1348 to modulate the combined Tx signal 1347 into a modulated Tx signal 1349 over an interconnect frequency channel, e.g., as described below.

In some demonstrative aspects, the communication interface may be configured to transmit the modulated Tx signal 1349 to the RH 1310, e.g., as described below.

In some demonstrative aspects, as shown in FIG. 13, radar processor 1336 may include a plurality of groups 1341 of Tx analog chains, e.g., including M groups of Tx analog chains, denoted #1-#M, which may be configured to generate a plurality of modulated Tx signals 1353, e.g., including M modulated signals 1353, over a respective plurality of interconnect frequency channels, denoted #λ1-#λM, e.g., as described below.

In some demonstrative aspects, as shown in FIG. 13, radar processor 1336 may include a multiplexer 1394 to generate a multiplexed Tx signal 1355, for example, by multiplexing the plurality of modulated Tx signals 1353, e.g., as described below.

In some demonstrative aspects, as shown in FIG. 13, the multiplexer 1394 may be configured to multiplex the modulated analog LO signal 1364 together with the multiplexed Tx signal 1355.

In some demonstrative aspects, as shown in FIG. 13, the communication interface 1331 may be configured to transmit the multiplexed Tx signal 1355 to the RH 1310, e.g., as described below.

In some demonstrative aspects, as shown in FIG. 13, the communication interface 1331 may be configured to receive the plurality of analog radar Rx signals 1324 from the RH 1310, for example, over a plurality of Rx frequency channels, e.g., including the n Rx frequency channels f1-fn, e.g., as described below.

In some demonstrative aspects, as shown in FIG. 13, the plurality of Rx analog chains 1320 may be configured to provide a plurality of analog baseband Rx signals 1325, for example, based on the plurality of analog radar Rx signals 1324, e.g., as described below.

In some demonstrative aspects, as shown in FIG. 13, an Rx analog chain 1320 of the plurality of Rx analog chains 1320 may be configured to generate an analog baseband Rx signal 1325, for example, based on an analog radar Rx signal 1324 over an Rx frequency channel corresponding to the Rx analog chain, e.g., as described below.

In some demonstrative aspects, as shown in FIG. 13, the Rx analog chain 1320 may include an Rx mixer 1326 to provide the analog baseband Rx signal 1325, for example, by mixing a combined Rx signal 1323 with a frequency signal 1363 corresponding to the Rx frequency channel for the Rx analog chain, e.g., as described below.

In some demonstrative aspects, as shown in FIG. 13, the combined Rx signal 1323 may include the plurality of analog radar Rx signals 1324 over a frequency bandwidth including the plurality of Rx frequency channels, e.g., as described below.

In some demonstrative aspects, as shown in FIG. 13, the plurality of Rx analog chains 1320 may include a first Rx analog chain, and a second Rx analog chain, e.g., as described below.

In some demonstrative aspects, as shown in FIG. 13, the first Rx analog chain may include a first Rx mixer to provide a first analog baseband Rx signal, for example, by mixing the combined Rx signal 1323 with a first frequency signal corresponding to a first Rx frequency channel. For example, the first Rx analog chain may include an Rx mixer 1326 to provide a first analog baseband Rx signal 1325, for example, by mixing the combined Rx signal 1323 with a first frequency signal 1363 corresponding to a first Rx frequency channel, e.g., as described below.

In some demonstrative aspects, as shown in FIG. 13, the second Rx analog chain may include a second Rx mixer to provide a second analog baseband Rx signal, for example, by mixing the combined Rx signal 1323 with a second frequency signal corresponding to a second Rx frequency channel. For example, the second Rx analog chain may include an Rx mixer 1328 to provide a second analog baseband Rx signal 1325, for example, by mixing the combined Rx signal 1323 with a second frequency signal 1363 corresponding to a second Rx frequency channel, e.g., as described below.

In some demonstrative aspects, as shown in FIG. 13, radar processor 1336 may include a demodulator 1322 configured to provide the combined Rx signal 1323, for example, by demodulating a modulated Rx signal 1319 over an interconnect frequency channel, e.g., as described below.

In some demonstrative aspects, as shown in FIG. 13, radar processor 1336 may include a splitter 1318 to provide the combined Rx signal 1323 to the plurality of Rx analog chains 1320, e.g., as described below.

In some demonstrative aspects, as shown in FIG. 13, the communication interface 1331 may be configured to receive from the RH 1310 a multiplexed Rx signal 1317 over an interconnect frequency bandwidth including a plurality of interconnect frequency channels, for example, including the N interconnect frequency channels #λ1-#λN, e.g., as described below.

In some demonstrative aspects, as shown in FIG. 13, the radar processor 1336 may include a splitter 1318 configured to split the multiplexed Rx signal 1317 into a plurality of modulated Rx signals 1319, over the plurality of interconnect frequency channels, respectively, e.g., as described below.

In some demonstrative aspects, as shown in FIG. 13, the radar processor 1336 may include a plurality of groups of Rx analog chains 1321, e.g., including N groups, denoted #1-#N, configured to process the plurality of modulated Rx signals 1319, respectively, e.g., as described above.

In some demonstrative aspects, as shown in FIG. 13, the radar processor 1336 may include a plurality of groups of analog chains. For example, the radar processor 1336 may include the plurality of groups 1341 of Tx analog chains and/or the plurality of groups 1321 of Rx analog chains.

In some demonstrative aspects, the frequency generator 1362 may be configured to provide the plurality of frequency signals 1363 to the plurality of groups of analog chains, e.g., as described below.

In one example, the plurality of frequency signals 1363 may include the plurality of Rx frequency signals and/or the plurality of Tx frequency signals.

In some demonstrative aspects, the communication interface 1331 may be configured to communicate with the RH 1310 a multiplexed analog radar signal over an interconnect frequency bandwidth including a plurality of interconnect frequency channels, e.g., as described below.

In some demonstrative aspects, the multiplexed analog radar signal may include a plurality of modulated analog radar signals over the plurality of interconnect frequency channels, respectively, e.g., as described above.

In some demonstrative aspects, the plurality of modulated analog radar signals may include the plurality of modulated Rx signals 1319 and/or the plurality of modulated Tx signals 1353.

In some demonstrative aspects, a modulated analog radar signal may be based on a combined analog radar signal including a plurality of analog radar signals over the plurality of frequency channels, e.g., as described above.

In some demonstrative aspects, a group of analog chains may be configured to process the plurality of analog radar signals of the combined analog radar signal, e.g., as described above.

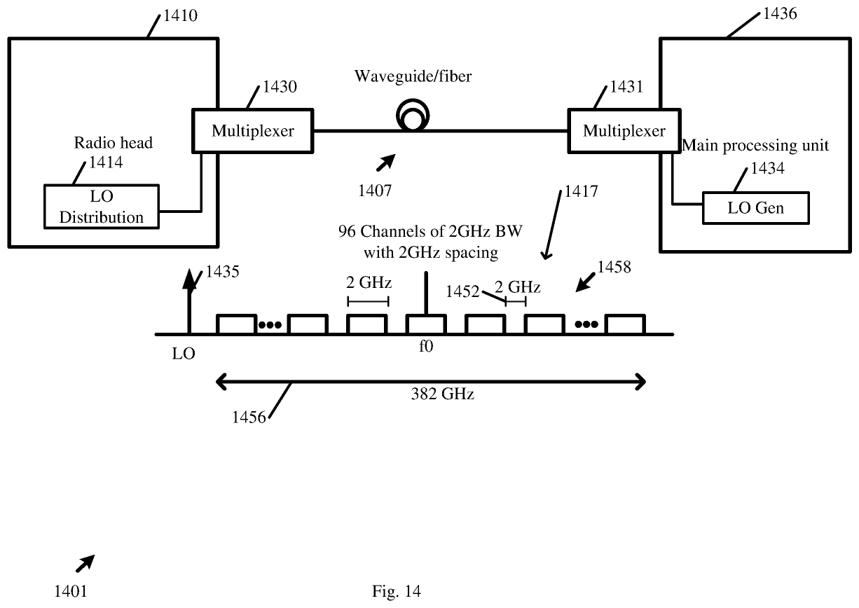

Reference is made to FIG. 14, which schematically illustrates an interconnect scheme 1401 to support communication between an RH 1410 and a radar processor 1436 via a communication interconnect 1407. For example, RH 1410 may include one or more elements of RH 1210 (FIG. 12), and/or may perform one or more operations and/or functionalities of 1210 (FIG. 12); radar processor 1436 may include one or more elements of radar processor 1336 (FIG. 13), and/or may perform one or more operations and/or functionalities of radar processor 1336 (FIG. 13); and/or communication interconnect 1107 (FIG. 11) may include one or more elements of communication interconnect 1407, and/or may perform one or more operations and/or functionalities of communication interconnect 1407.

In some demonstrative aspects, communication interconnect 1407 may be configured to communicate information and/or data between radar processor 1436 and RH 1410.

In some demonstrative aspects, as shown in FIG. 14, communication interconnect 1407 may include a fiber optic interconnect and/or a dielectric waveguide interconnect.

In other aspects, any other additional or alternative interconnect may be implemented.

In some demonstrative aspects, communication interconnect 1407 may include the fiber optic interconnect and/or the dielectric waveguide interconnect, for example, to support an increased effective bandwidth, e.g., as described below.

In one example, as shown in FIG. 14, communication interconnect 1407 may include the fiber optic interconnect. For example, a similar architecture may be implemented for the dielectric waveguide interconnect.

In some demonstrative aspects, there may be one or more differences between the fiber optic interconnect and the dielectric waveguide interconnect, e.g., as described below.

In one example, a total available bandwidth of a fiber optic interconnect may be different from a total available bandwidth of a dielectric waveguide interconnect, e.g., a mmWave/sub Tera HZ waveguide interconnect.

In another example, a frequency of operation of the fiber optic interconnect may be in a frequency domain of THz, while the frequency of operation of the dielectric waveguide interconnect may be in a frequency domain of GHz.

In another example, physical sizes of optical bundles and dielectric bundles may be different.

In another example, dielectric waveguide interconnectors be more robust for automotive environments, e.g., compared to the fiber optic interconnect, for example, due to reduced alignment requirements and/or lower overall cost, e.g., of polymer materials, CMOS implantation, and/or the like.

In some demonstrative aspects, as shown in FIG. 14, RH 1410 may be configured to communicate with the radar processor 1436 a multiplexed analog radar signal 1417 over an interconnect frequency bandwidth 1456 including a plurality of interconnect frequency channels.

In some demonstrative aspects, the multiplexed analog radar signal 1417 may include a plurality of modulated analog radar signals 1458 over the plurality of interconnect frequency channels.

In some demonstrative aspects, as shown in FIG. 14, RH 1410 may include a multiplexer 1430 to multiplex the plurality of modulated analog radar signals 1458, and/or radar processor 1436 may include a multiplexer 1431 to multiplex the plurality of modulated analog radar signals 1458.

In some demonstrative aspects, the plurality of modulated analog radar signals 1458 may include analog radar Tx signals and/or analog radar Rx signals.

In some demonstrative aspects, RH 1410 may include N transmit antennas and/or M receive antennas, for example, to utilize a high-resolution antenna array.

In one example, the number N of transmit antennas may be between 3 and 48, e.g., N=48, 24, 16, 12, 6 and 3; and/or the number M of receive antennas may be between 3 and 48, e.g., M=48, 24, 16, 8, 4.

In another example, any other number of transmit and/or receive antennas may be implemented.

In some demonstrative aspects, RH 1410 may include M transmit chains and N receive chains, for example, to support a total of N+M independent radar waveforms. Accordingly, a full bandwidth of N+M waveforms may be communicated between the RH 1410 and the radar processor 1436, e.g., via the plurality of modulated analog radar signals 1458, for example, in case RH 1410 does not include processing capabilities.

In some demonstrative aspects, a “thin” architecture of RH 1410, e.g., as described above, may be implemented, for example, to provide a technical solution to support utilization of a small form factor, lightweight, and/or power-efficient radio-head, which may be easily installed around a vehicle.

In one example, the number N of transmit antennas may be 48, the number M of receive antennas may be 48, and a waveform bandwidth of a waveform may be 2 GHz. According to this example, a relatively large effective bandwidth of about 200 GHz, for example, may be required to support communication between RH 1410 and radar processor 1436. This effective bandwidth may include, for example, about 96 GHz, e.g., 96=48×2 GHz, for communicating analog Rx signals from the receive chains of RH 140, and about 96 GHz, e.g. 96=48×2 GHz, for communicating analog Tx signals to the transmit chains of RH 1410.

In some demonstrative aspects, the plurality of radar waveforms, e.g., the N+M radar waveforms, may be aggregated around an optical wavelength, denoted f0, e.g., f0=1550 nm, or any other optical wavelength.

In some demonstrative aspects, the plurality of radar waveforms, e.g., the N+M radar waveforms, may be aggregated around a mmWave carrier, e.g., a mmWave carrier between 100-500 GHz, or any other carrier.

In some demonstrative aspects, a guard spacing frequency may be maintained between the different radar waveforms, for example, to effectively split the different waveforms and/or to reduce cross-talk between the different channels. For example, this guard spacing may even further increase the total effective bandwidth.

In some demonstrative aspects, as shown in FIG. 14, a guard spacing 1452, e.g., of 2 GHz or any other pacing, may be maintained between the waveforms 1458. According to this implementation, an effective bandwidth 1456, e.g., of the optical fiber interconnect or the mmWave/sub-THz waveguide, may be 382 GHz.

In other aspects, any other guard spacing frequency may be implemented.

In some demonstrative aspects, two or more communication interconnects 1407 may be used, for example, to support the effective bandwidth, e.g., using a fiber bundle and/or a waveguide bundle.

In some demonstrative aspects, the interconnect 1407 may be configured to communicate analog synchronization information from the radar processor 1436 to the RH 1410. For example, radar processor 1436 may be configured to multiplex the analog synchronization information with the modulated analog radar signals 1458, e.g., as described below.

In some demonstrative aspects, the analog synchronization information may include an LO signal 1435.

In some demonstrative aspects, as shown in FIG. 14, radar processor 1436 may include an LO generator 1434 configured to generate the LO signal 1435.

In some demonstrative aspects, as shown in FIG. 14, RH 1410 may include an LO distributor 1414 configured to distribute the LO signal 1435 to one or more radio chains of the RH 1410, e.g., as described above.

In some demonstrative aspects, as shown in FIG. 14, communication interconnect 1407 may be configured to transfer the LO signal 1435 from radar processor 1436 to RH 1410, for example, by multiplexing the LO signal 1435 with the plurality of modulated analog radar signals 1458.

In some demonstrative aspects, LO signal 1435 may be configured for synchronization between the main processing unit 1436 and a plurality of RHs 1410, for example, in a multi-static architecture.

In some demonstrative aspects, aggregation of the waveforms 1458 may be performed in one or more TxSIPs and RxSIPs of the RH 1410, and/or in one or more TxSIPs and/or RxSIPs in the radar processor 1436, for example, utilizing subdivisions of the total bandwidth 1456, e.g., as described below.

In some demonstrative aspects, a TxSIP may include m channels, e.g., of the M Tx channels, which may support m Tx antennas or more, e.g., of the M Tx antennas, e.g., as described below.

In some demonstrative aspects, an RxSIP may process n waveforms, e.g., of the N waveforms, from n Rx antennas or more, e.g., of the N Rx antennas, e.g., as described below.

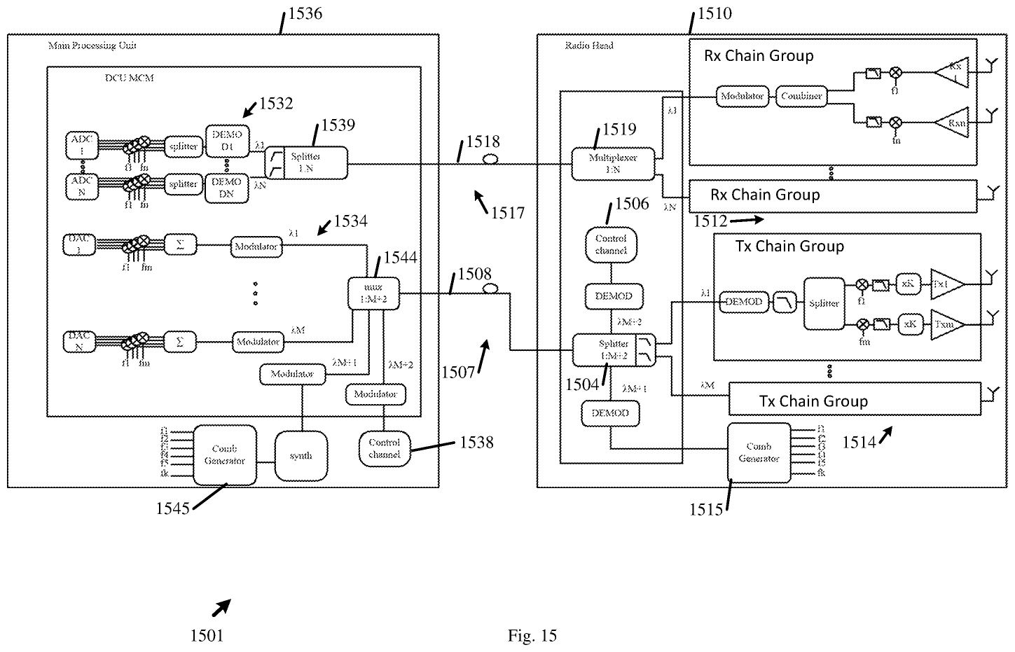

Reference is made to FIG. 15, which schematically illustrates a radar system 1501, in accordance with some demonstrative aspects. For example, radar system 1201 (FIG. 12) may include one or more elements of radar system 1501, and/or may perform one or more operations and/or functionalities of radar system 1501.

In some demonstrative aspects, as shown in FIG. 15, radar system 1501 may include a radar processing unit (also referred to as “main unit”, “main processor, “central processor”, “radar processor” or “radar controller”) 1536. For example, radar processor 1336 (FIG. 13) may include one or more elements of radar processing unit 1536, and/or may perform one or more operations and/or functionalities of radar processing unit 1536.

In some demonstrative aspects, as shown in FIG. 15, radar system 1501 may include one or more RHs, e.g., including an RH 1510. For example, RH 1210 (FIG. 12) may include one or more elements of RH 1510, and/or may perform one or more operations and/or functionalities of RH 1510.

In some demonstrative aspects, as shown in FIG. 15, radar system 1501 may include a first communication interconnect 1507 and a second communication interconnect 1517.

In some demonstrative aspects, communication interconnect 1507 may include a fiber optic interconnect, a dielectric waveguide interconnect, and/or a conducted cable interconnect.

In other aspects, any other additional or alternative interconnect may be implemented.

In some demonstrative aspects, communication interconnect 1517 may include a fiber optic interconnect, a dielectric waveguide interconnect, and/or a conducted cable interconnect. In other aspects, any other additional or alternative interconnect may be implemented.

In some demonstrative aspects, as shown in FIG. 15, communication interconnect 1517 may be configured to transfer a multiplexed Rx signal 1518 from RH 1510 to radar processor 1536.

In some demonstrative aspects, multiplexed Rx signal 1518 may include a plurality of N modulated Rx signals, for example over N interconnect Rx frequency channels, denoted λ1-λN. For example, communication interconnect 1517 may be configured to support communication of N Rx waveforms.

In some demonstrative aspects, as shown in FIG. 15, RH 1510 may include a plurality of groups 1512 of Rx chains to generate the plurality of N modulated Rx signals, and a multiplexer 1519 to generate the multiplexed Rx signal 1518, for example, by multiplexing the plurality of N modulated Rx signals.

In some demonstrative aspects, as shown in FIG. 15, radar processor 1536 may include a splitter 1539 to split the multiplexed Rx signal 1518 into the plurality of N modulated Rx signals.

In some demonstrative aspects, as shown in FIG. 15, radar processor 1536 may include a plurality of groups 1532 of Rx analog chains to process the plurality of N modulated Rx signals, respectively.

In some demonstrative aspects, as shown in FIG. 15, communication interconnect 1507 may be configured to transfer a multiplexed Tx signal 1508 from radar processor 1536 to RH 1510.

In some demonstrative aspects, multiplexed Tx signal 1508 may include a plurality of M modulated Tx signals, for example over M interconnect Tx frequency channels, denoted λ1-λM.

In some demonstrative aspects, as shown in FIG. 15, radar processor 1536 may include a plurality of groups 1534 of Tx analog chains to generate the plurality of M modulated Tx signals.

In some demonstrative aspects, as shown in FIG. 15, radar processor 1536 may include a multiplexer 1544 to generate the multiplexed Tx signal 1508, for example, by multiplexing the plurality of M modulated Tx signals.

In some demonstrative aspects, as shown in FIG. 15, the RH 1510 may include a splitter 1504 to split the multiplexed Tx signal 1508 into the plurality of M modulated Tx signals over the plurality of M interconnect Tx frequency channels, respectively.

In some demonstrative aspects, as shown in FIG. 15, the RH 1510 may include a plurality of groups 1514 of Tx chains to process the plurality of M modulated Tx signals, respectively.

In some demonstrative aspects, multiplexed Tx signal 1508 may include modulated analog synchronization information, for example, over an M+1 interconnect frequencies, denoted M+1.

In some demonstrative aspects, as shown in FIG. 15, radar processor 1536 may include a frequency generator 1545 configured to generate the analog synchronization information, e.g., as described above.

In some demonstrative aspects, as shown in FIG. 15, RH 1510 processor 1536 may include a frequency generator 1552 configured to generate a plurality of frequency signals corresponding to the plurality of frequency channels based on the analog synchronization information from the radar processor 1536, e.g., as described above.

In some demonstrative aspects, as shown in FIG. 15, the analog synchronization information, may be transferred from frequency generator 1545 to frequency generator 1515, for example, via multiplexer 1544 and splitter 1504.

In some demonstrative aspects, multiplexed Tx signal 1508 may include modulated control information, for example, over an M+2 interconnect frequency, denoted M+2.

In one example, the modulated control information may be communicated over a low data rate channel, e.g., via communication interconnect 1507, for example, to support calibration and/or control of RH 1510.

In some demonstrative aspects, as shown in FIG. 15, radar processor 1536 may include a controller 1538 configured to generate the control information.

In some demonstrative aspects, as shown in FIG. 15, RH 1510 may include a controller 1506, configured to control one or more operations and/or functionalities of RH 1510, for example, based on the modulated control information.

In some demonstrative aspects, multiplexed Tx signal 1508 may include M+2 modulated waveforms, e.g., including the M Tx waveforms, the waveform to communicate the synchronization information and the waveform to communicate the control information. For example, communication interconnect 1507 may be configured to support communication of the M+2 waveforms.

In some demonstrative aspects, a radar system may include a single communication interconnect, for example, to transfer both the multiplexed Tx signal 1508 and the multiplexed Rx signal 1518, e.g., as described below.

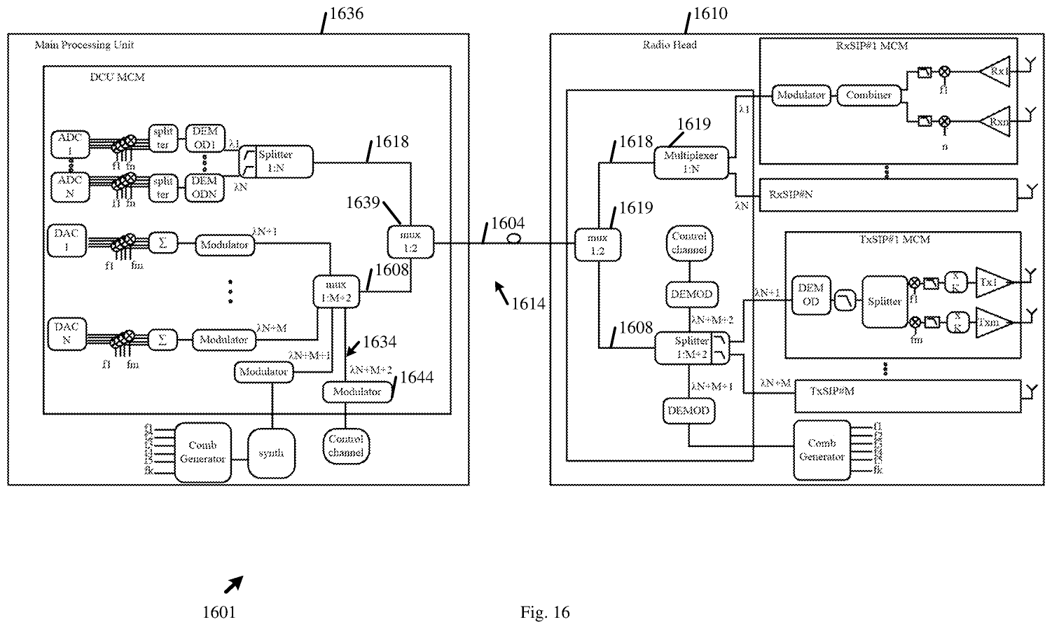

Reference is made to FIG. 16, which schematically illustrates a radar system 1601, in accordance with some demonstrative aspects. For example, radar system 1101 (FIG. 11) may include one or more elements of radar system 1601, and/or may perform one or more operations and/or functionalities of radar system 1601.

In some demonstrative aspects, as shown in FIG. 16, radar system 1601 may include a radar processing unit (also referred to as “main unit”, “main processor, “central processor”, “radar processor” or “radar controller”) 1634. For example, radar processor 1336 (FIG. 13) may include one or more elements of radar processing unit 1634, and/or may perform one or more operations and/or functionalities of radar processing unit 1634.

In some demonstrative aspects, as shown in FIG. 16, radar system 1601 may include one or more RHs, e.g., including an RH 1610. For example, RH 1210 (FIG. 12) may include one or more elements of RH 1610, and/or may perform one or more operations and/or functionalities of RH 1610.

In some demonstrative aspects, as shown in FIG. 16, radar system 1601 may include a communication interconnect 1614, e.g., a single communication interconnect.

In some demonstrative aspects, communication interconnect 1614 may include a fiber optic interconnect, and/or a dielectric waveguide interconnect. In other aspects, any other additional or alternative interconnect may be implemented.

In some demonstrative aspects, as shown in FIG. 16, communication interconnect 1614 may be configured to communicate multiplexed analog signals 1604 between RH 1610 and radar processor 1636.

In some demonstrative aspects, multiplexed analog signals 1604 may include a multiplexed Rx signal 1618, and/or a multiplexed Tx signal 1608. For example, multiplexed Rx signal 1618 may include multiplexed Rx signal 1518 (FIG. 15), and/or multiplexed Tx signal 1608 may include multiplexed Tx signal 1508 (FIG. 15).

In some demonstrative aspects, as shown in FIG. 16, RH 1610 may include a multiplexer 1619 configured multiplex the multiplexed Rx signal 1618 and the multiplexed Tx signal 1608 over interconnect frequencies of the communication interconnect 1614.

In some demonstrative aspects, as shown in FIG. 16, radar processor 1636 may include multiplexer 1639 configured to multiplex the multiplexed Rx signal 1618 and the multiplexed Tx signal 1608 over interconnect frequencies of the communication interconnect 1614.

In some demonstrative aspects, as shown in FIG. 16, multiplexed Rx signal 1618 may include a plurality of N modulated Rx signals, for example, over the N interconnect Rx frequencies λ1-λN, e.g., as described above.

In some demonstrative aspects, multiplexed Tx signal 1608 may include a plurality of M modulated Tx signals, for example, over the M interconnect Tx frequencies λ1-λM, e.g., as described above.

In some demonstrative aspects, multiplexed Tx signal 1608 may include modulated analog synchronization information, for example, over the interconnect frequency M+1, e.g., as described above.

In some demonstrative aspects, multiplexed Tx signal 1608 may include modulated control information, for example, over the interconnect frequency M+2.

In some demonstrative aspects, communication interconnect 1614 may be configured to support communication of N+M+2 modulated waveforms between RH 1610 and radar processor 1636, e.g., including the N Rx waveforms, the M Tx waveforms, the waveform to communicate the synchronization information and the waveform to communicate the control information.

In some demonstrative aspects, multiplexer 1619 and/or multiplexer 1639 may include a relatively large multiplexers, for example, to support multiplexing of the N+M+2 modulated waveforms.

In some demonstrative aspects, for example, in some implementations and/or use cases, a radar system may be configured to implement a Tx-only RH and/or an Rx-only RH, for example, to reduce cost and/or complexity, for example, compared to implementing an RH, e.g., RH 1610, having both Tx and Rx capabilities.

In some demonstrative aspects, the Rx-only RH may include one or more RxSIPs, e.g., including only the plurality of groups 1512 (FIG. 15) of Rx chains.

In one example, the Tx-only RH may include one or more TxSIP, e.g., including only the plurality of groups 1514 (FIG. 15) of Tx chains.

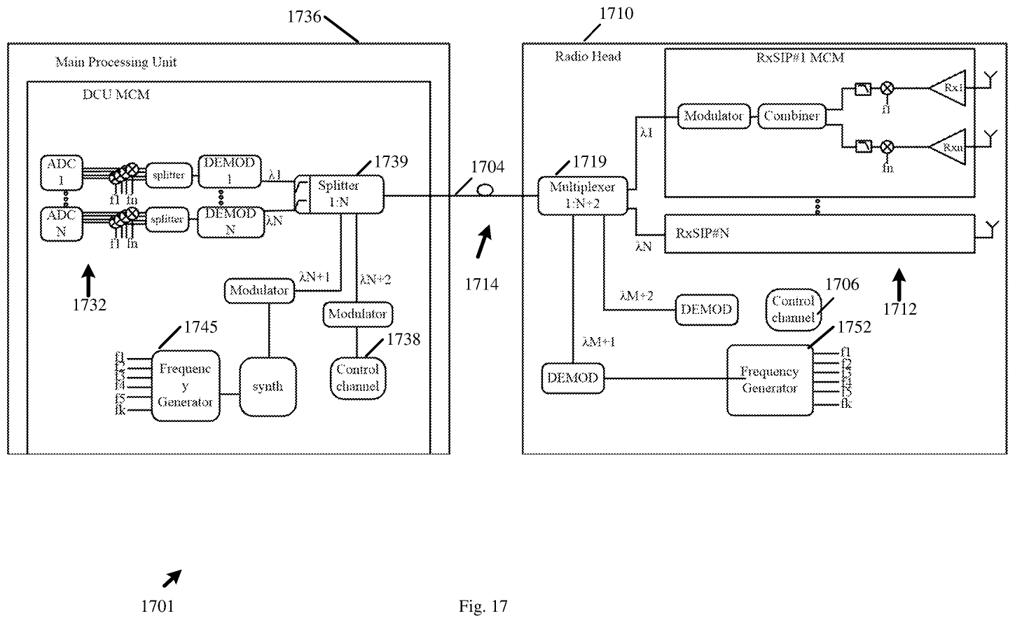

Reference is made to FIG. 17, which schematically illustrates a radar system 1701, in accordance with some demonstrative aspects. For example, radar system 1101 (FIG. 11) may include one or more elements of radar system 1701, and/or may perform one or more operations and/or functionalities of radar system 1701.

In some demonstrative aspects, as shown in FIG. 17, radar system 1701 may include a radar processing unit (also referred to as “main unit”, “main processor, “central processor”, “radar processor” or “radar controller”) 1736. For example, radar processor 1336 (FIG. 13) may include one or more elements of radar processing unit 1736, and/or may perform one or more operations and/or functionalities of radar processing unit 1736.

In some demonstrative aspects, as shown in FIG. 17, radar system 1701 may include one or more RHs, e.g., including an RH 1710. For example, RH 1210 (FIG. 12) may include one or more elements of RH 1710, and/or may perform one or more operations and/or functionalities of RH 1710.

In some demonstrative aspects, as shown in FIG. 17, radar system 1701 may include a communication interconnect 1714, e.g., a single communication interconnect.

In some demonstrative aspects, communication interconnect 1714 may include a fiber optic interconnect, and/or a dielectric waveguide interconnect. In other aspects, any other additional or alternative interconnect may be implemented.

In some demonstrative aspects, as shown in FIG. 17, communication interconnect 1714 may be configured to transfer a multiplexed Rx signal 1704 from RH 1710 to radar processor 1736.

In some demonstrative aspects, multiplexed Rx signal 1704 may include a plurality of N modulated Rx signals, for example, over the N interconnect Rx frequencies λ1-λN.

In some demonstrative aspects, as shown in FIG. 17, RH 1710 may include a plurality of groups 1712 of Rx chains to generate the plurality of N modulated Rx signals.

In some demonstrative aspects, as shown in FIG. 17, RH 1710 may include an Rx-only RH, for example, having only Rx capabilities. For example, RH 1710 may include only the plurality of groups 1712 of Rx chains, e.g., excluding Tx chains.

In some demonstrative aspects, as shown in FIG. 17, RH 1710 may include a multiplexer 1719 to generate the multiplexed Rx signal 1704, for example, by multiplexing the plurality of N modulated Rx signals.

In some demonstrative aspects, as shown in FIG. 17, radar processor 1736 may include a splitter 1739 to split the multiplexed Rx signal 1704 into the plurality of N modulated Rx signals.

In some demonstrative aspects, as shown in FIG. 17, radar processor 1736 may include a plurality of groups 1732 of Rx analog chains to process the plurality of N modulated Rx signals, respectively.

In some demonstrative aspects, as shown in FIG. 17, communication interconnect 1714 may be configured to transfer modulated analog synchronization information from radar processor 1736 to RH 1710, for example, over an interconnect frequency N+1, and/or to transfer modulated control information from radar processor 1736 to RH 1710, for example, over an interconnect frequency N+2.

In some demonstrative aspects, as shown in FIG. 17, radar processor 1736 may include a frequency generator 1745 configured to generate the analog synchronization information.

In some demonstrative aspects, as shown in FIG. 17, RH 1710 processor 1736 may include a frequency generator 1752 configured to generate a plurality of frequency signals corresponding to the plurality of frequency channels based on the analog synchronization information from the radar processor 1736.

In some demonstrative aspects, as shown in FIG. 17, radar processor 1736 may include a controller 1738 configured to generate the control information.

In some demonstrative aspects, as shown in FIG. 17, RH 1710 may include a controller 1706 configured to control one or more operations and/or functionalities of RH 1710, for example, based on the control information from the radar processor 1736.

In some demonstrative aspects, interconnect 1714 may be configured to support communication of N+2 modulated waveforms, e.g., the N Rx waveforms, the waveform to communicate the synchronization information, and the waveform to communicate the control information.

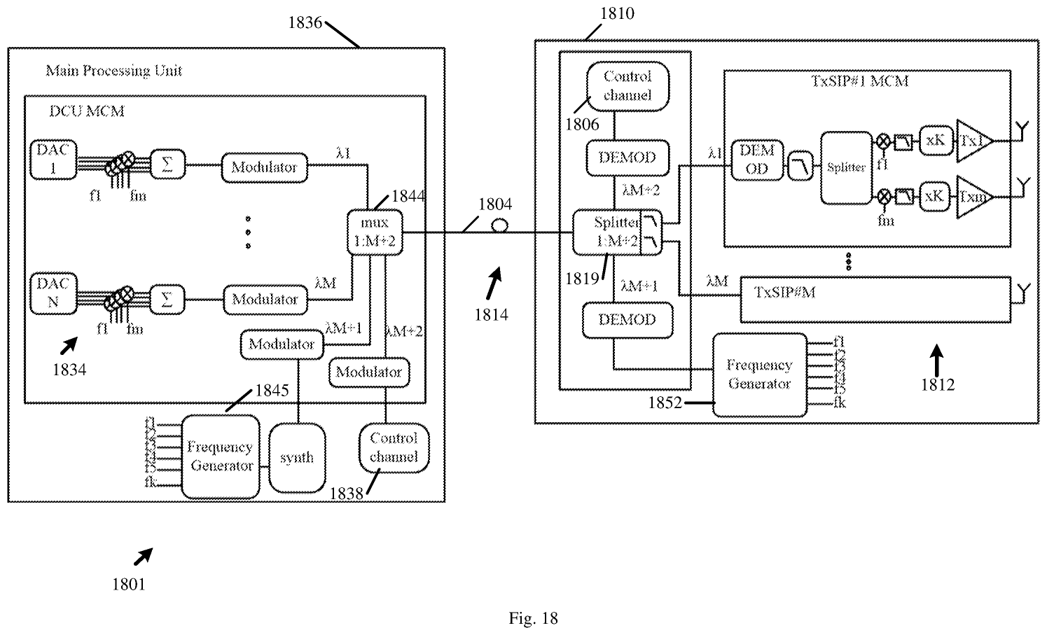

Reference is made to FIG. 18, which schematically illustrates a radar system 1801, in accordance with some demonstrative aspects. For example, radar system 1101 (FIG. 11) may include one or more elements of radar system 1801, and/or may perform one or more operations and/or functionalities of radar system 1801.

In some demonstrative aspects, as shown in FIG. 18, radar system 1801 may include a radar processing unit (also referred to as “main unit”, “main processor, “central processor”, “radar processor” or “radar controller”) 1834. For example, radar processor 1336 (FIG. 13) may include one or more elements of radar processing unit 1834, and/or may perform one or more operations and/or functionalities of radar processing unit 1834.

In some demonstrative aspects, as shown in FIG. 18, radar system 1801 may include one or more RHs, e.g., including an RH 1810. For example, RH 1210 (FIG. 12) may include one or more elements of RH 1810, and/or may perform one or more operations and/or functionalities of RH 1810.

In some demonstrative aspects, as shown in FIG. 18, radar system 1801 may include a communication interconnect 1814, e.g., a single communication interconnect.

In some demonstrative aspects, communication interconnect 1814 may include a fiber optic interconnect, and/or a dielectric waveguide interconnect. In other aspects, any other additional or alternative interconnect may be implemented.

In some demonstrative aspects, as shown in FIG. 18, communication interconnect 1814 may be configured to transfer a multiplexed Tx signal 1804 from radar processor 1836 to RH 1810.

In some demonstrative aspects, multiplexed Tx signal 1804 may include a plurality of M modulated Tx signals, for example, over the M interconnect Tx frequencies λ1-λM.

In some demonstrative aspects, as shown in FIG. 18, radar processor 1836 may include a plurality of groups 1834 of Tx analog chains to generate the plurality of M modulated Tx signals.

In some demonstrative aspects, as shown in FIG. 18, radar processor 1836 may include multiplexer 1844 to generate the multiplexed Tx signal 1804, for example, by multiplexing the plurality of M modulated Tx signals.

In some demonstrative aspects, as shown in FIG. 18, the RH 1810 may include a splitter 1819 to split the multiplexed Tx signal 1804 into the plurality of M modulated Tx signals over the plurality of interconnect frequency channels, respectively.

In some demonstrative aspects, as shown in FIG. 18, RH 1810 may include a plurality of groups 1812 of Tx chains configured to process the plurality of M modulated Tx signals, respectively.

In some demonstrative aspects, as shown in FIG. 18, RH 1810 may include a Tx-only RH having, for example, only Tx capabilities. For example, RH 1810 may include only the plurality of groups 1812 of Tx chains, e.g., excluding Rx chains.

In some demonstrative aspects, multiplexed Tx signal 1804 may include modulated analog synchronization information, for example, over the interconnect waveform λM+1.

In some demonstrative aspects, as shown in FIG. 18, radar processor 1836 may include a frequency generator 1845 configured to generate the analog synchronization information.

In some demonstrative aspects, as shown in FIG. 18, RH 1810 processor 1836 may include a frequency generator 1852 configured to generate a plurality of frequency signals corresponding to the plurality of frequency channels, for example, based on the analog synchronization information.

In some demonstrative aspects, as shown in FIG. 18, the analog synchronization information may be transferred from frequency generator 1845 to frequency generator 1852, for example, via multiplexer 1844 and splitter 1819.

In some demonstrative aspects, interconnect 1814 may be configured to support communication of M+2 modulated waveforms, e.g., the M Tx waveforms, the waveform to communicate the synchronization information, and the waveform to communicate the control information.

In some demonstrative aspects, as shown in FIG. 18, radar processor 1836 may include a controller 1838 configured to generate the control information.

In some demonstrative aspects, as shown in FIG. 18, RH 1810 may include a controller 1806 configured to control one or more operations and/or functionalities of RH 1810, for example, based on the modulated control information from radar processor 1836.

In some demonstrative aspects, for example, in some implementations and/or use cases, a radar system may be configured to utilize a radar processor, which may exclude a frequency generator, e.g., frequency generator 1845 and/or frequency generator 1362 (FIG. 13), e.g., as described below.

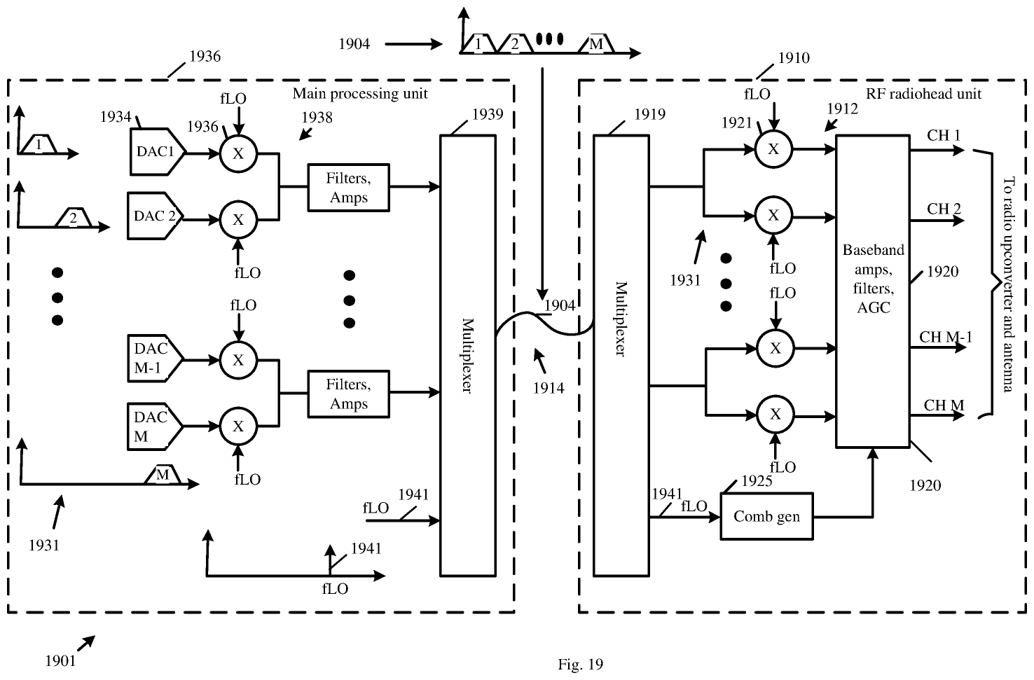

Reference is made to FIG. 19, which schematically illustrates a Tx scheme 1901 to support communication between an RH 1910 and a radar processor 1936 via a communication interconnect 1914. For example, RH 1210 (FIG. 12) may include one or more elements of RH 1910, and/or may perform one or more operations and/or functionalities of RH 1910; radar processor 1336 (FIG. 13) may include one or more elements of radar processor 1936, and/or may perform one or more operations and/or functionalities of radar processor 1936; and/or communication interconnect 1207 (FIG. 12) and/or communication interconnect 1307 (FIG. 13) may include one or more elements of communication interconnect 1914, and/or may perform one or more operations and/or functionalities of communication interconnect 1914.

In some demonstrative aspects, communication interconnect 1914 may include a fiber optic interconnect, and/or a dielectric waveguide interconnect. In other aspects, any other additional or alternative interconnect may be implemented.

In some demonstrative aspects, communication interconnect 1914 may be configured to transfer information and/or data in a direction (Tx direction) from radar processor 1936 to RH 1910.

In some demonstrative aspects, as shown in FIG. 19, communication interconnect 1914 may be configured to transfer a multiplexed Tx signal 1904 from radar processor 1936 to RH 1910.

In some demonstrative aspects, multiplexed Tx signal 1904 may include a plurality of digitally shifted baseband signals 1931.

In some demonstrative aspects, radar processor 1936 may be configured to generate the plurality of digitally shifted baseband signals 1931, for example, by digitally shifting a Tx waveform, e.g., each Tx waveform to a low-IF frequency.

In some demonstrative aspects, as shown in FIG. 19, radar processor 1936 may include a plurality of Tx chains 1938 configured to generate the plurality of digitally shifted baseband signals 1931.

In some demonstrative aspects, as shown in FIG. 19, a TX chain 1938 may include a DAC 1934 configured to output a shifted waveform at a low-IF.

In some demonstrative aspects, as shown in FIG. 19, the TX chain 1938 may include a mixer 1936 configured to up-convert the shifted waveform, for example, based on an LO tone 1941, e.g., a single LO tone 1941.

In some demonstrative aspects, radar processor 1936 may include a multiplexer 1939 configured to generate the multiplexed Tx signal 1904, for example, by multiplexing the plurality of digitally shifted baseband signals 1931.

In some demonstrative aspects, radar processor 1936 may be configured to aggregate the plurality of digitally shifted baseband signals 1931, e.g., at a baseband domain.

In some demonstrative aspects, as shown in FIG. 19, RH 1910 may include a multiplexer 1919 configured to de-multiplex the multiplexed Tx signal 1904 from radar processor 1936 into the plurality of digitally shifted baseband signals 1931.

In some demonstrative aspects, as shown in FIG. 19, RH 1910 may include a plurality of Tx chains 1912 configured to process the plurality of digitally shifted baseband signals 1931, respectively.

In some demonstrative aspects, as shown in FIG. 19, a TX chain 1912 may include a mixer 1921 configured to down-convert a respective digitally shifted baseband signal 1931.

In some demonstrative aspects, as shown in FIG. 19, RH 1910 may include one or more baseband elements 1920 to perform further baseband processing of the digitally shifted baseband signals 1931.

In some demonstrative aspects, as shown in FIG. 19, an LO tone, for example, a single LO tone, e.g., LO tone 1941, may be utilized at the radar processor 1936 to perform the up conversion to a wavelength of the interconnect 1914, e.g., a mmWave/sub-THz wavelength (100-500 GHz) or an optical wavelength.

In some demonstrative aspects, RH 1910 may include a frequency generator 1925 to support down-conversion with frequency offsets for the analog separation of the multiplexed Tx signal 1904, for example, based on the LO tone from the radar processor 1936.

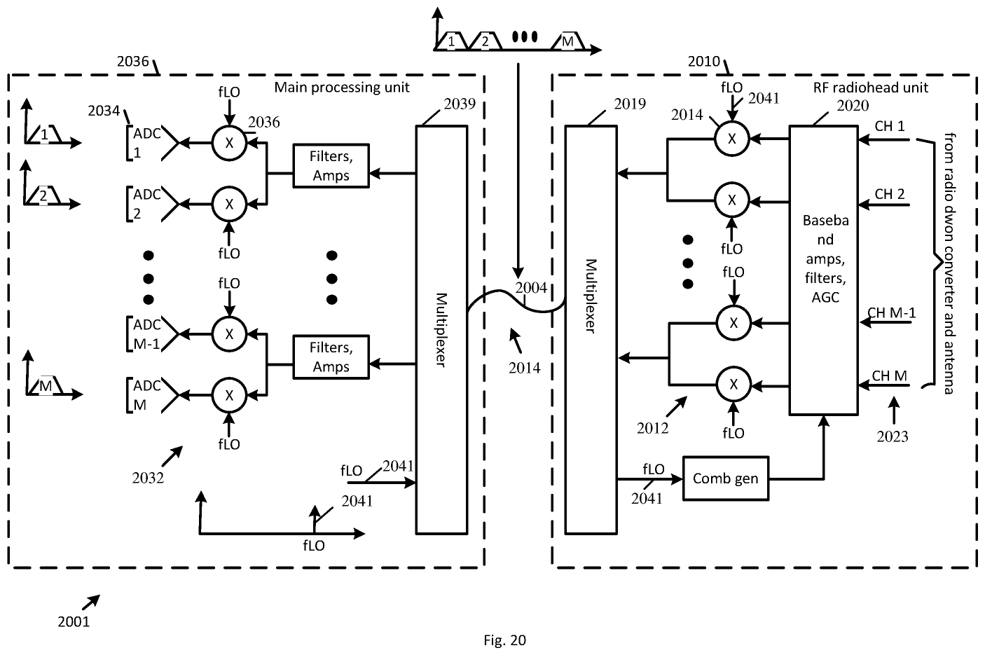

Reference is made to FIG. 20, which schematically illustrates a Rx scheme 2001 to support communication between an RH 2010 and a radar processor 2036 via a communication interconnect 2014. For example, RH 1210 (FIG. 12) may include one or more elements of RH 2010, and/or may perform one or more operations and/or functionalities of RH 2010; radar processor 1336 (FIG. 13) may include one or more elements of radar processor 2036, and/or may perform one or more operations and/or functionalities of radar processor 2036; and/or communication interconnect 1207 (FIG. 12) and/or communication interconnect 1307 (FIG. 13) may include one or more elements of communication interconnect 2014, and/or may perform one or more operations and/or functionalities of communication interconnect 2014.

In some demonstrative aspects, communication interconnect 2014 may include a fiber optic interconnect, and/or a dielectric waveguide interconnect. In other aspects, any other additional or alternative interconnect may be implemented.

In some demonstrative aspects, communication interconnect 2014 may be configured to transfer information and/or data in a direction (Rx direction) from RH 2110 to radar processor 2036.

In some demonstrative aspects, as shown in FIG. 20, communication interconnect 2014 may be configured to transfer a multiplexed Rx signal 2004 from RH 2010 to radar processor 2036.

In some demonstrative aspects, as shown in FIG. 20, RH 2010 may include one or more baseband elements 2020 configured to perform baseband processing of a plurality of radar Rx signals 2023.

In some demonstrative aspects, as shown in FIG. 20, RH 2010 may include a plurality of Rx chains 2012 configured to receive the plurality of radar Rx signals 2023, e.g., via a plurality of antennas.

In some demonstrative aspects, as shown in FIG. 20, an Rx chain 2012 may include a mixer 2014 configured to up-convert a radar Rx signal 2023.

In some demonstrative aspects, as shown in FIG. 20, RH 2010 may include a multiplexer 2020 configured to generate the multiplexed Rx signal 2004 by multiplexing the plurality of upconverted radar Rx signals 2023.

In some demonstrative aspects, radar processor 2036 may include a multiplexer 2039 configured to de-multiplex the multiplexed Rx signal 2004 from RH 2010 into the plurality of Rx signals 2023.

In some demonstrative aspects, as shown in FIG. 20, radar processor 2036 may include a plurality of Rx chains 2032 configured to process the plurality of radar Rx signals 2023.

In some demonstrative aspects, as shown in FIG. 20, an Rx chain 2032 may include a mixer 2036 configured to down-convert a radar Rx signal 2023, for example, based on an LO tone 2041, for example, a single LO tone 2041.

In some demonstrative aspects, as shown in FIG. 20, the Rx chain 2032 may include an ADC 2034 configured to output a digital radar signal, for example, based on the down-converted radar Rx signal 2023, for example, for further processing.

In some demonstrative aspects, the ADC 2034 may sample a relatively high bandwidth baseband signal, e.g., the downconverted radar Rx signal 2023, and may perform any remaining splitting and/or filtering of each waveform. For example, a single LO, e.g., LO tone 2041, may be utilized by radar processor 2036, for example, to perform down conversion of the radar Rx signals 2023, e.g., to the baseband domain. For example, RH 2010 may include a frequency generator 2025 to support up-conversion for the aggregation and transmission of the plurality of radar Rx signals 2023 via communication interconnect 2014.

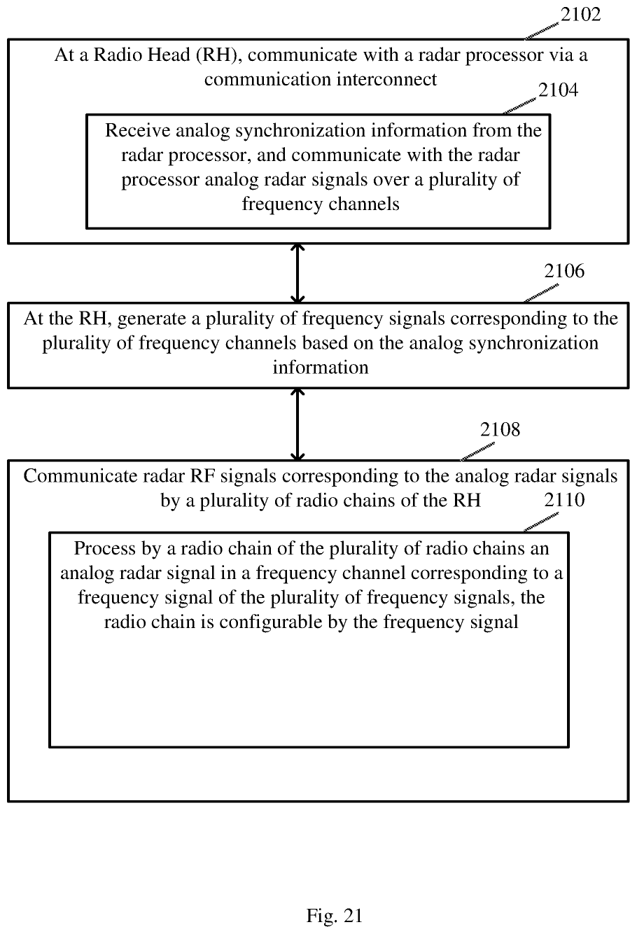

Reference is made to FIG. 21, which schematically illustrates a method of radar processing, in accordance with some demonstrative aspects. For example, one or more of the operations of the method of FIG. 21 may be performed by a radar system, e.g., radar system 900 (FIG. 9), radar system 1001 (FIG. 10), radar system 1101 (FIG. 11), radar system 1201 (FIG. 12), and/or radar system 1301 (FIG. 13); a radar device, e.g., radar device 1002 (FIG. 10); and/or a radio head, e.g., RH 1010 (FIG. 10), RH 1110 (FIG. 11), and/or RH 1210 (FIG. 12).

As indicated at block 2102, the method may include communicating, at an RH, information with a radar processor via a communication interconnect. For example, RH 1210 (FIG. 12) may communicate with radar processor 1210 (FIG. 12) via the communication interconnect 1207 (FIG. 12), e.g., as described above.

As indicated at block 2104, communicating the information with the radar processor may include receiving analog synchronization information from the radar processor, and communicating with the radar processor analog radar signals over a plurality of frequency channels. For example, RH 1210 (FIG. 12) may receive the analog synchronization information 1232 (FIG. 12) from the radar processor 1236 (FIG. 12), and may communicate with the radar processor 1236 (FIG. 12) the analog radar signals 1238 (FIG. 12) over the plurality of frequency channels, e.g., as described above.

As indicated at block 2106, the method may include generating, at the RH, a plurality of frequency signals corresponding to the plurality of frequency channels, for example, based on the analog synchronization information. For example, RH 1210 (FIG. 12) may generate the plurality of frequency signals 1263 (FIG. 12) corresponding to the plurality of frequency channels, for example, based on the analog synchronization information 1232 (FIG. 12), e.g., as described above.

As indicated at block 2108, the method may include communicating by a plurality of radio chains of the RH radar RF signals corresponding to the analog radar signals. For example, RH 1210 (FIG. 12) may communicate by the plurality of radio chains of RH 1210 (FIG. 1) the radar RF signals corresponding to the analog radar signals 1238 (FIG. 12), e.g., as described above.

As indicated at block 2110, communicating the radar RF signals corresponding to the analog radar signals may include processing by a radio chain of the plurality of radio chains an analog radar signal in a frequency channel corresponding to a frequency signal of the plurality of frequency signals. For example, the radio chain may be configurable by the frequency signal. For example, RH 1210 (FIG. 12) may process the analog radar signal in the frequency channel corresponding to the frequency signal 1264 (FIG. 12) of the plurality of frequency signals 1263 (FIG. 12), e.g., as described above.

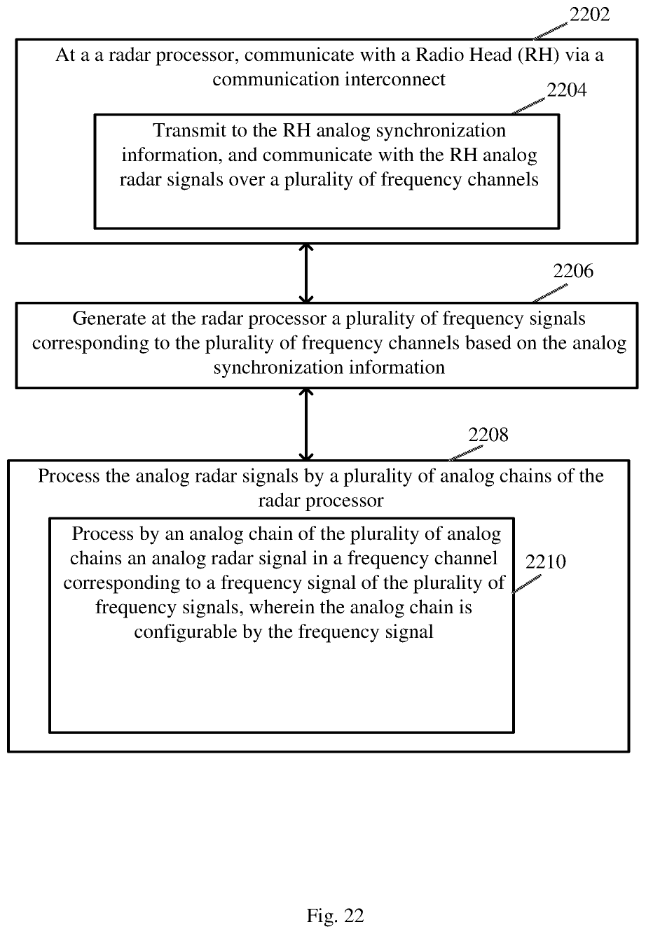

Reference is made to FIG. 22, which schematically illustrates a method of radar processing, in accordance with some demonstrative aspects. For example, one or more of the operations of the method of FIG. 22 may be performed by a radar system, e.g., radar system 900 (FIG. 9), radar system 1001 (FIG. 10), radar system 1101 (FIG. 11), radar system 1201 (FIG. 12), and/or radar system 1301 (FIG. 13); a radar device, e.g., radar device 1002 (FIG. 10); and/or a radar processor, e.g., radar processing unit 1034 (FIG. 10), radar processor 1036 (FIG. 10), radar processor 1136 (FIG. 11), and/or radar processor 1336 (FIG. 13).

As indicated at block 2202, the method may include communicating, at a radar processor, information with a RH via a communication interconnect. For example, radar processor 1336 (FIG. 13) may communicate with RH 1310 (FIG. 13) via the communication interconnect 1307 (FIG. 13), e.g., as described above.

As indicated at block 2204, communicating the information with the radar processor may include transmitting to the RH analog synchronization information, and communicating with the RH analog radar signals over a plurality of frequency channels. For example, radar processor 1336 (FIG. 13) may transmit the analog synchronization information 1332 (FIG. 13) to the RH 1310 (FIG. 13), and may communicate with the RH 1310 (FIG. 13) the analog radar signals 1338 (FIG. 13) over the plurality of frequency channels 1363 (FIG. 13), e.g., as described above.

As indicated at block 2206, the method may include generating at the radar processor a plurality of frequency signals corresponding to the plurality of frequency channels based on the analog synchronization information. For example, radar processor 1336 (FIG. 13) may generate the plurality of frequency signals 1363 (FIG. 13) corresponding to the plurality of frequency channels, for example, based on the analog synchronization information 1332 (FIG. 13), e.g., as described above.

As indicated at block 2208, the method may include processing the analog radar signals by a plurality of analog chains of the radar processor. For example, radar processor 1336 (FIG. 13) may process the analog radar signals 1338 (FIG. 13) by the plurality of analog chains, e.g., as described above.

As indicated at block 2210, processing the analog radar signals by the plurality of analog chains may include processing by an analog chain of the plurality of analog chains an analog radar signal in a frequency channel corresponding to a frequency signal of the plurality of frequency signals. For example, the analog chain may be configurable by the frequency signal. For example, an analog chain of radar processor 1336 (FIG. 13) may process the analog radar signal in the frequency channel corresponding to the frequency signal 1363 (FIG. 13), e.g., as described above.

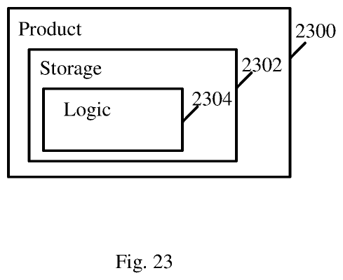

Reference is made to FIG. 23, which schematically illustrates a product of manufacture 2300, in accordance with some demonstrative aspects. Product 2300 may include one or more tangible computer-readable (“machine-readable”) non-transitory storage media 2302, which may include computer-executable instructions, e.g., implemented by logic 2304, operable to, when executed by at least one computer processor, enable the at least one computer processor to implement one or more operations and/or functionalities described with reference to any of the FIGS. 1-22, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2300 and/or machine-readable storage media 2302 may include one or more types of computer-readable storage media capable of storing data, including volatile memory, non-volatile memory, removable or non-removable memory, erasable or non-erasable memory, writeable or re-writeable memory, and the like. For example, machine-readable storage media 2302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a Radio Head (RH) comprising a communication interface configured to communicate with a radar processor via a communication interconnect, wherein the communication interface is configured to receive analog synchronization information from the radar processor, and to communicate with the radar processor analog radar signals over a plurality of frequency channels; a frequency generator configured to generate a plurality of frequency signals corresponding to the plurality of frequency channels based on the analog synchronization information; and a plurality of radio chains to communicate radar Radio Frequency (RF) signals corresponding to the analog radar signals, wherein a radio chain of the plurality of radio chains is configurable by a frequency signal of the plurality of frequency signals to process an analog radar signal in a frequency channel corresponding to the frequency signal.

Example 2 includes the subject matter of Example 1, and optionally, wherein the plurality of radio chains comprises a plurality of Receive (Rx) chains to generate a plurality of analog radar Rx signals based on a plurality of radar Rx RF signals, wherein the communication interface is configured to send the plurality of analog radar Rx signals to the radar processor over a plurality of Rx frequency channels.

Example 3 includes the subject matter of Example 2, and optionally, wherein an Rx chain of the plurality of Rx chains comprises an Rx mixer to provide an analog radar Rx signal over an Rx frequency channel by mixing a radar Rx RF signal with a frequency signal corresponding to the Rx frequency channel.

Example 4 includes the subject matter of Example 2 or 3, and optionally, wherein the RH comprises a combiner to combine the plurality of analog radar Rx signals into a combined Rx signal over a frequency bandwidth comprising the plurality of Rx frequency channels, and a modulator to modulate the combined Rx signal into a modulated Rx signal over an interconnect frequency channel, wherein the communication interface is configured to transmit the modulated Rx signal to the radar processor.

Example 5 includes the subject matter of Example 4, and optionally, wherein the RH comprises a plurality of groups of Rx chains to generate a plurality of modulated Rx signals over a respective plurality of interconnect frequency channels, and a multiplexer to generate a multiplexed Rx signal by multiplexing the plurality of modulated Rx signals, wherein the communication interface is configured to transmit the multiplexed Rx signal to the radar processor.

Example 6 includes the subject matter of any one of Examples 2-5, and optionally, wherein the plurality of Rx chains comprises a first Rx chain and a second Rx chain, wherein the first Rx chain comprises a first Rx mixer to provide a first analog radar Rx signal over a first Rx frequency channel by mixing a first radar Rx RF signal with a first frequency signal corresponding to the first Rx frequency channel, wherein the second Rx chain comprises a second Rx mixer to provide a second analog radar Rx signal over a second Rx frequency channel by mixing a second radar Rx RF signal with a second frequency signal corresponding to the second Rx frequency channel.

Example 7 includes the subject matter of any one of Examples 1-6, and optionally, wherein the communication interface is configured to receive a plurality of analog radar Transmit (Tx) signals from the radar processor over a plurality of Tx frequency channels, wherein the plurality of radio chains comprises a plurality of Tx chains to transmit a plurality of radar Tx RF signals based on the plurality of analog radar Tx signals.

Example 8 includes the subject matter of Example 7, and optionally, wherein a Tx chain of the plurality of Tx chains is configured to transmit a radar Tx RF signal based on an analog radar Tx signal over a Tx frequency channel, wherein the Tx chain comprises a Tx mixer to provide an Intermediate Frequency (IF) signal by mixing a combined Tx signal with a frequency signal corresponding to the Tx frequency channel, wherein the combined Tx signal comprises the plurality of analog radar Tx signals over a frequency bandwidth comprising the plurality of Tx frequency channels, wherein the radar Tx RF signal is based on the IF signal.

Example 9 includes the subject matter of Example 7 or 8, and optionally, wherein the RH comprises a demodulator to provide the combined Tx signal by demodulating a modulated Tx signal over an interconnect frequency channel, and a splitter to provide the combined Tx signal to the plurality of Tx chains.

Example 10 includes the subject matter of Example 9, and optionally, wherein the communication interface is configured to receive from the radar processor a multiplexed Tx signal over an interconnect frequency bandwidth comprising a plurality of interconnect frequency channels, wherein the RH comprises a splitter to split the multiplexed Tx signal into a plurality of modulated Tx signals over the plurality of interconnect frequency channels, respectively, and a plurality of groups of Tx chains to process the plurality of modulated Tx signals, respectively.

Example 11 includes the subject matter of any one of Examples 7-10, and optionally, wherein the plurality of Tx chains comprises a first Tx chain and a second Tx chain, wherein the first Tx chain comprises a first Tx mixer to provide a first IF signal by mixing the combined Tx signal with a first frequency signal corresponding to a first Tx frequency channel, wherein the second Tx chain comprises a second Tx mixer to provide a second IF signal by mixing the combined Tx signal with a second frequency signal corresponding to a second Tx frequency channel.

Example 12 includes the subject matter of any one of Examples 1-11, and optionally, wherein the RH comprises a plurality of groups of radio chains, wherein the frequency generator is configured to provide the plurality of frequency signals to the plurality of groups of radio chains.

Example 13 includes the subject matter of Example 12, and optionally, wherein the communication interface is configured to communicate with the radar processor a multiplexed analog radar signal over an interconnect frequency bandwidth comprising a plurality of interconnect frequency channels, wherein the multiplexed analog radar signal comprises a plurality of modulated analog radar signals over the plurality of interconnect frequency channels, respectively, wherein a modulated analog radar signal is based on a combined analog radar signal comprising a plurality of analog radar signals over the plurality of frequency channels, wherein a group of radio chains is configured to process the plurality of analog radar signals of the combined analog radar signal.

Example 14 includes the subject matter of any one of Examples 1-13, and optionally, wherein the analog synchronization information comprises an analog Local Oscillator (LO) signal.

Example 15 includes the subject matter of any one of Examples 1-14, and optionally, wherein the analog synchronization information comprises time synchronization information to synchronize in time the radar RF signals.

Example 16 includes the subject matter of any one of Examples 1-15, and optionally, wherein the communication interface is configured to communicate the analog radar signals modulated over one or more first electromagnetic waveforms via a waveguide interconnect, and to communicate the analog synchronization information over a second electromagnetic waveform via the waveguide interconnect.

Example 17 includes the subject matter of any one of Examples 1-16, and optionally, wherein the communication interface comprises a fiber optic communication interface to communicate the analog synchronization information, and the analog radar signals via a fiber optic interconnect.

Example 18 includes the subject matter of any one of Examples 1-17, and optionally, wherein the communication interface comprises an Active Optical Cable (AOC) communication interface to communicate the analog synchronization information, and the analog radar signals via an AOC interconnect.

Example 19 includes the subject matter of any one of Examples 1-18, and optionally, wherein the communication interface comprises a dielectric waveguide communication interface to communicate the analog synchronization information, and the analog radar signals via a dielectric waveguide interconnect.

Example 20 includes an apparatus comprising a radar processor configured to process radar information corresponding to radar communications of one or more Radio Heads (RHs), the radar processor comprising a communication interface configured to communicate with an RH via a communication interconnect, wherein the communication interface is configured to transmit to the RH analog synchronization information, and to communicate with the RH analog radar signals over a plurality of frequency channels; a frequency generator configured to generate a plurality of frequency signals corresponding to the plurality of frequency channels based on the analog synchronization information; and a plurality of analog chains to process the analog radar signals, wherein an analog chain of the plurality of analog chains is configurable by a frequency signal of the plurality of frequency signals to process an analog radar signal in a frequency channel corresponding to the frequency signal.

Example 21 includes the subject matter of Example 20, and optionally, wherein the plurality of analog chains comprises a plurality of Transmit (Tx) analog chains to generate a plurality of analog radar Tx signals over a plurality of Tx frequency channels, wherein the communication interface is configured to send the plurality of analog radar Tx signals to the RH.

Example 22 includes the subject matter of Example 21, and optionally, wherein a Tx chain of the plurality of Tx chains comprises a Tx mixer to provide an analog radar Tx signal over a Tx frequency channel by mixing an analog baseband Tx signal with a frequency signal corresponding to the Tx frequency channel.

Example 23 includes the subject matter of Example 21 or 22, and optionally, wherein the radar processor comprises a combiner to combine the plurality of analog radar Tx signals into a combined Tx signal over a frequency bandwidth comprising the plurality of Tx frequency channels, and a modulator to modulate the combined Tx signal into a modulated Tx signal over an interconnect frequency channel, wherein the communication interface is configured to transmit the modulated Tx signal to the RH.

Example 24 includes the subject matter of Example 23, and optionally, wherein the radar processor comprises a plurality of groups of Tx analog chains to generate a plurality of modulated Tx signals over a respective plurality of interconnect frequency channels, and a multiplexer to generate a multiplexed Tx signal by multiplexing the plurality of modulated Tx signals, wherein the communication interface is configured to transmit the multiplexed Tx signal to the RH.

Example 25 includes the subject matter of any one of Examples 21-24, and optionally, wherein the plurality of Tx analog chains comprises a first Tx analog chain and a second Tx analog chain, wherein the first Tx analog chain comprises a first Tx mixer to provide a first analog radar Tx signal over a first Tx frequency channel by mixing a first analog baseband Tx signal with a first frequency signal corresponding to the first Tx frequency channel, wherein the second Tx analog chain comprises a second Tx mixer to provide a second analog radar Tx signal over a second Tx frequency channel by mixing a second analog baseband Tx signal with a second frequency signal corresponding to the second Tx frequency channel.

Example 26 includes the subject matter of any one of Examples 20-25, and optionally, wherein the communication interface is configured to receive a plurality of analog radar Receive (Rx) signals from the RH over a plurality of Rx frequency channels, wherein the plurality of analog chains comprises a plurality of Rx analog chains to provide a plurality of analog baseband Rx signals based on the plurality of analog radar Rx signals.

Example 27 includes the subject matter of Example 26, and optionally, wherein an Rx analog chain of the plurality of Rx analog chains is configured to generate an analog baseband Rx signal based on an analog radar Rx signal over an Rx frequency channel, wherein the Rx analog chain comprises an Rx mixer to provide the analog baseband Rx signal by mixing a combined Rx signal with a frequency signal corresponding to the Rx frequency channel, wherein the combined Rx signal comprises the plurality of analog radar Rx signals over a frequency bandwidth comprising the plurality of Rx frequency channels.

Example 28 includes the subject matter of Example 26 or 27, and optionally, wherein the radar processor comprises a demodulator to provide the combined Rx signal by demodulating a modulated Rx signal over an interconnect frequency channel, and a splitter to provide the combined Rx signal to the plurality of Rx analog chains.

Example 29 includes the subject matter of Example 28, and optionally, wherein the communication interface is configured to receive from the RH a multiplexed Rx signal over an interconnect frequency bandwidth comprising a plurality of interconnect frequency channels, wherein the radar processor comprises a splitter to split the multiplexed Rx signal into a plurality of modulated Rx signals over the plurality of interconnect frequency channels, respectively, and a plurality of groups of Rx analog chains to process the plurality of modulated Rx signals, respectively.

Example 30 includes the subject matter of any one of Examples 26-29, and optionally, wherein the plurality of Rx analog chains comprises a first Rx analog chain and a second Rx analog chain, wherein the first Rx analog chain comprises a first Rx mixer to provide a first analog baseband Rx signal by mixing the combined Rx signal with a first frequency signal corresponding to a first Rx frequency channel, wherein the second Rx analog chain comprises a second Rx mixer to provide a second analog baseband Rx signal by mixing the combined Rx signal with a second frequency signal corresponding to a second Rx frequency channel.

Example 31 includes the subject matter of any one of Examples 20-30, and optionally, wherein the radar processor comprises a plurality of groups of analog chains, wherein the frequency generator is configured to provide the plurality of frequency signals to the plurality of groups of analog chains.

Example 32 includes the subject matter of Example 31, and optionally, wherein the communication interface is configured to communicate with the RH a multiplexed analog radar signal over an interconnect frequency bandwidth comprising a plurality of interconnect frequency channels, wherein the multiplexed analog radar signal comprises a plurality of modulated analog radar signals over the plurality of interconnect frequency channels, respectively, wherein a modulated analog radar signal is based on a combined analog radar signal comprising a plurality of analog radar signals over the plurality of frequency channels, wherein a group of analog chains is configured to process the plurality of analog radar signals of the combined analog radar signal.

Example 33 includes the subject matter of any one of Examples 20-32, and optionally, wherein the analog synchronization information comprises an analog Local Oscillator (LO) signal.

Example 34 includes the subject matter of any one of Examples 20-33, and optionally, wherein the analog synchronization information comprises time synchronization information to synchronize in time the communications of the one or more RHs.

Example 35 includes the subject matter of any one of Examples 20-34, and optionally, wherein the communication interface is configured to communicate the analog radar signals modulated over one or more first electromagnetic waveforms via a waveguide interconnect, and to communicate the analog synchronization information over a second electromagnetic waveform via the waveguide interconnect.

Example 36 includes the subject matter of any one of Examples 20-35, and optionally, wherein the communication interface comprises a fiber optic communication interface to communicate the analog synchronization information, and the analog radar signals via a fiber optic interconnect.

Example 37 includes the subject matter of any one of Examples 20-36, and optionally, wherein the communication interface comprises an Active Optical Cable (AOC) communication interface to communicate the analog synchronization information, and the analog radar signals via an AOC interconnect.

Example 38 includes the subject matter of any one of Examples 20-37, and optionally, wherein the communication interface comprises a dielectric waveguide communication interface to communicate the analog synchronization information, and the analog radar signals via a dielectric waveguide interconnect.

Example 39 includes the subject matter of any one of Examples 1-38, and optionally, comprising a vehicle, the vehicle comprising a system controller to control one or more systems of the vehicle based on radar information, the radar information based on the analog radar signals.

Example 40 includes a vehicle comprising the apparatus of any of Examples 1-38.

Example 41 includes an apparatus comprising means for executing any of the described operations of any of Examples 1-38.

Example 42 includes a machine-readable medium that stores instructions for execution by a processor to perform any of the described operations of any of Examples 1-38.

Example 43 comprises a product comprising one or more tangible computer-readable non-transitory storage media comprising instructions operable to, when executed by at least one processor, enable the at least one processor to cause a device to perform any of the described operations of any of Examples 1-38.

Example 44 includes an apparatus comprising a memory; and processing circuitry configured to perform any of the described operations of any of Examples 1-38.

Example 45 includes a method including any of the described operations of any of Examples 1-38.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-25. (canceled)

26. An apparatus comprising:
a Radio Head (RH) comprising:
a communication interface configured to communicate with a radar processor via a communication interconnect, wherein the communication interface is configured to receive analog synchronization information from the radar processor, and to communicate with the radar processor analog radar signals over a plurality of frequency channels;
a frequency generator configured to generate a plurality of frequency signals corresponding to the plurality of frequency channels based on the analog synchronization information; and
a plurality of radio chains to communicate radar Radio Frequency (RF) signals corresponding to the analog radar signals, wherein a radio chain of the plurality of radio chains is configurable by a frequency signal of the plurality of frequency signals to process an analog radar signal in a frequency channel corresponding to the frequency signal.

27. The apparatus of claim 26, wherein the plurality of radio chains comprises a plurality of Receive (Rx) chains to generate a plurality of analog radar Rx signals based on a plurality of radar Rx RF signals, wherein the communication interface is configured to send the plurality of analog radar Rx signals to the radar processor over a plurality of Rx frequency channels.

28. The apparatus of claim 27, wherein an Rx chain of the plurality of Rx chains comprises an Rx mixer to provide an analog radar Rx signal over an Rx frequency channel by mixing a radar Rx RF signal with a frequency signal corresponding to the Rx frequency channel.

29. The apparatus of claim 27, wherein the RH comprises a combiner to combine the plurality of analog radar Rx signals into a combined Rx signal over a frequency bandwidth comprising the plurality of Rx frequency channels, and a modulator to modulate the combined Rx signal into a modulated Rx signal over an interconnect frequency channel, wherein the communication interface is configured to transmit the modulated Rx signal to the radar processor.

30. The apparatus of claim 29, wherein the RH comprises a plurality of groups of Rx chains to generate a plurality of modulated Rx signals over a respective plurality of interconnect frequency channels, and a multiplexer to generate a multiplexed Rx signal by multiplexing the plurality of modulated Rx signals, wherein the communication interface is configured to transmit the multiplexed Rx signal to the radar processor.

31. The apparatus of claim 27, wherein the plurality of Rx chains comprises a first Rx chain and a second Rx chain, wherein the first Rx chain comprises a first Rx mixer to provide a first analog radar Rx signal over a first Rx frequency channel by mixing a first radar Rx RF signal with a first frequency signal corresponding to the first Rx frequency channel, wherein the second Rx chain comprises a second Rx mixer to provide a second analog radar Rx signal over a second Rx frequency channel by mixing a second radar Rx RF signal with a second frequency signal corresponding to the second Rx frequency channel.

32. The apparatus of claim 26, wherein the communication interface is configured to receive a plurality of analog radar Transmit (Tx) signals from the radar processor over a plurality of Tx frequency channels, wherein the plurality of radio chains comprises a plurality of Tx chains to transmit a plurality of radar Tx RF signals based on the plurality of analog radar Tx signals.

33. The apparatus of claim 32, wherein a Tx chain of the plurality of Tx chains is configured to transmit a radar Tx RF signal based on an analog radar Tx signal over a Tx frequency channel, wherein the Tx chain comprises a Tx mixer to provide an Intermediate Frequency (IF) signal by mixing a combined Tx signal with a frequency signal corresponding to the Tx frequency channel, wherein the combined Tx signal comprises the plurality of analog radar Tx signals over a frequency bandwidth comprising the plurality of Tx frequency channels, wherein the radar Tx RF signal is based on the IF signal.

34. The apparatus of claim 32, wherein the RH comprises a demodulator to provide the combined Tx signal by demodulating a modulated Tx signal over an interconnect frequency channel, and a splitter to provide the combined Tx signal to the plurality of Tx chains.

35. The apparatus of claim 34, wherein the communication interface is configured to receive from the radar processor a multiplexed Tx signal over an interconnect frequency bandwidth comprising a plurality of interconnect frequency channels, wherein the RH comprises a splitter to split the multiplexed Tx signal into a plurality of modulated Tx signals over the plurality of interconnect frequency channels, respectively, and a plurality of groups of Tx chains to process the plurality of modulated Tx signals, respectively.

36. The apparatus of claim 32, wherein the plurality of Tx chains comprises a first Tx chain and a second Tx chain, wherein the first Tx chain comprises a first Tx mixer to provide a first IF signal by mixing the combined Tx signal with a first frequency signal corresponding to a first Tx frequency channel, wherein the second Tx chain comprises a second Tx mixer to provide a second IF signal by mixing the combined Tx signal with a second frequency signal corresponding to a second Tx frequency channel.

37. The apparatus of claim 26, wherein the RH comprises a plurality of groups of radio chains, wherein the frequency generator is configured to provide the plurality of frequency signals to the plurality of groups of radio chains.

38. The apparatus of claim 37, wherein the communication interface is configured to communicate with the radar processor a multiplexed analog radar signal over an interconnect frequency bandwidth comprising a plurality of interconnect frequency channels, wherein the multiplexed analog radar signal comprises a plurality of modulated analog radar signals over the plurality of interconnect frequency channels, respectively, wherein a modulated analog radar signal is based on a combined analog radar signal comprising a plurality of analog radar signals over the plurality of frequency channels, wherein a group of radio chains is configured to process the plurality of analog radar signals of the combined analog radar signal.

39. An apparatus comprising:
a radar processor configured to process radar information corresponding to radar communications of one or more Radio Heads (RHs), the radar processor comprising:
a communication interface configured to communicate with an RH of the one or more RHs via a communication interconnect, wherein the communication interface is configured to transmit to the RH analog synchronization information, and to communicate with the RH analog radar signals over a plurality of frequency channels;
a frequency generator configured to generate a plurality of frequency signals corresponding to the plurality of frequency channels based on the analog synchronization information; and
a plurality of analog chains to process the analog radar signals, wherein an analog chain of the plurality of analog chains is configurable by a frequency signal of the plurality of frequency signals to process an analog radar signal in a frequency channel corresponding to the frequency signal.

40. The apparatus of claim 39, wherein the plurality of analog chains comprises a plurality of Transmit (Tx) analog chains to generate a plurality of analog radar Tx signals over a plurality of Tx frequency channels, wherein the communication interface is configured to send the plurality of analog radar Tx signals to the RH.

41. The apparatus of claim 40, wherein the radar processor comprises a combiner to combine the plurality of analog radar Tx signals into a combined Tx signal over a frequency bandwidth comprising the plurality of Tx frequency channels, and a modulator to modulate the combined Tx signal into a modulated Tx signal over an interconnect frequency channel, wherein the communication interface is configured to transmit the modulated Tx signal to the RH.

42. The apparatus of claim 41, wherein the radar processor comprises a plurality of groups of Tx analog chains to generate a plurality of modulated Tx signals over a respective plurality of interconnect frequency channels, and a multiplexer to generate a multiplexed Tx signal by multiplexing the plurality of modulated Tx signals, wherein the communication interface is configured to transmit the multiplexed Tx signal to the RH.

43. The apparatus of claim 39, wherein the communication interface is configured to receive a plurality of analog radar Receive (Rx) signals from the RH over a plurality of Rx frequency channels, wherein the plurality of analog chains comprises a plurality of Rx analog chains to provide a plurality of analog baseband Rx signals based on the plurality of analog radar Rx signals.

44. The apparatus of claim 43, wherein an Rx analog chain of the plurality of Rx analog chains is configured to generate an analog baseband Rx signal based on an analog radar Rx signal over an Rx frequency channel, wherein the Rx analog chain comprises an Rx mixer to provide the analog baseband Rx signal by mixing a combined Rx signal with a frequency signal corresponding to the Rx frequency channel, wherein the combined Rx signal comprises the plurality of analog radar Rx signals over a frequency bandwidth comprising the plurality of Rx frequency channels.

45. The apparatus of claim 44, wherein the radar processor comprises a demodulator to provide the combined Rx signal by demodulating a modulated Rx signal over an interconnect frequency channel, and a splitter to provide the combined Rx signal to the plurality of Rx analog chains.
